(19) United States
(12) Patent Application Publication
(10) Pub. No.: US 2026/0046975 A1
(43) Pub. Date: Feb. 12, 2026

(54) TRAFFIC PATTERN INFORMATION AND DISCONTINUOUS RECEPTION CONFIGURATION UPDATES

(71) Applicant: QUALCOMM Incorporated, San Diego, CA (US)

(72) Inventors: Liangping MA, San Diego, CA (US); Prasada Veera Reddy KADIRI, San Diego, CA (US); Prashanth Haridas HANDE, San Diego, CA (US); Sitaramanjaneyulu KANAMARLAPUDI, San Diego, CA (US)

(21) Appl. No.: 19/296,657

(22) Filed: Aug. 11, 2025

Related U.S. Application Data
(60) Provisional application No. 63/681,980, filed on Aug. 12, 2024.

(51) Int. Cl. H04W 76/28

(52) U.S. Cl. CPC H04W 76/28

(57) ABSTRACT

Various aspects of the present disclosure generally relate to wireless communication. In some aspects, a traffic source or an application function (AF) may determine traffic information including a packet periodicity associated with one or more traffic flows. The traffic source or the AF may transmit, to a network function, the traffic information including an identifier related to a first packet associated with the packet periodicity. Numerous other aspects are described.

### CROSS-REFERENCE TO RELATED APPLICATION

This Patent Application claims priority to U.S. Provisional Ser. No. 63/681,980, filed on Aug. 12, 2024, entitled “TRAFFIC PATTERN INFORMATION AND DISCONTINUOUS RECEPTION CONFIGURATION UPDATES,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods for updating traffic pattern information and discontinuous reception configurations.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of communication performed by a traffic source or application function. The method may include determining traffic information including a packet periodicity associated with one or more traffic flows. The method may include transmitting, to a network function, the traffic information including an identifier related to a first packet associated with the packet periodicity.

Some aspects described herein relate to a method of communication performed by a network function. The method may include receiving traffic information including a packet periodicity associated with one or more traffic flows and an identifier related to a first packet associated with the packet periodicity. The method may include transmitting the traffic information to a network node.

Some aspects described herein relate to a method of communication performed by a user plane function (UPF). The method may include receiving traffic information including a packet periodicity associated with one or more traffic flows. The method may include transmitting the traffic information to a network node.

Some aspects described herein relate to a method of communication performed by a user plane of a network node. The method may include receiving traffic information including a packet periodicity associated with one or more traffic flows. The method may include transmitting the traffic information to a control plane of the network node. The method may include receiving an acknowledgement, from the control plane of the network node, that the traffic information has been used.

Some aspects described herein relate to a method of communication performed by a control plane of a network node. The method may include receiving, from a user plane of the network node, traffic information including a packet periodicity associated with one or more traffic flows. The method may include transmitting an acknowledgement, to the user plane of the network node, that the traffic information has been used.

Some aspects described herein relate to a method of wireless communication performed by a user equipment (UE). The method may include receiving a control element associated with a discontinuous reception (DRX) cycle performed by the UE. The method may include monitoring according to a modified DRX cycle at a time after receiving the control element.

Some aspects described herein relate to a method of wireless communication performed by a network node. The method may include receiving traffic information including a packet periodicity associated with one or more traffic flows. The method may include transmitting a control element, associated with a DRX cycle, based at least in part on the traffic information.

Some aspects described herein relate to an apparatus for communication at a traffic source or application function. The apparatus may include one or more memories comprising processor-executable instructions and one or more processors. The one or more processors may be configured to execute the processor-executable instructions and cause the apparatus to determine traffic information including a packet periodicity associated with one or more traffic flows. The one or more processors may be configured to execute the processor-executable instructions and cause the apparatus to transmit, to a network function, the traffic information including an identifier related to a first packet associated with the packet periodicity.

Some aspects described herein relate to an apparatus for communication at a network function. The apparatus may include one or more memories comprising processor-executable instructions and one or more processors. The one or more processors may be configured to execute the processor-executable instructions and cause the apparatus to receive traffic information including a packet periodicity associated with one or more traffic flows and an identifier related to a first packet associated with the packet periodicity. The one or more processors may be configured to execute the processor-executable instructions and cause the apparatus to transmit the traffic information to a network node.

Some aspects described herein relate to an apparatus for communication at a UPF. The apparatus may include one or more memories comprising processor-executable instructions and one or more processors. The one or more processors may be configured to execute the processor-executable instructions and cause the apparatus to receive traffic information including a packet periodicity associated with one or more traffic flows. The one or more processors may be configured to execute the processor-executable instructions and cause the apparatus to transmit the traffic information to a network node.

Some aspects described herein relate to an apparatus for communication at a user plane of network node. The apparatus may include one or more memories comprising processor-executable instructions and one or more processors. The one or more processors may be configured to execute the processor-executable instructions and cause the apparatus to receive traffic information including a packet periodicity associated with one or more traffic flows. The one or more processors may be configured to execute the processor-executable instructions and cause the apparatus to transmit the traffic information to a control plane of the network node. The one or more processors may be configured to execute the processor-executable instructions and cause the apparatus to receive an acknowledgement, from the control plane of the network node, that the traffic information has been used.

Some aspects described herein relate to an apparatus for communication at a control plane of a network node. The apparatus may include one or more memories comprising processor-executable instructions and one or more processors. The one or more processors may be configured to execute the processor-executable instructions and cause the apparatus to receive, from a user plane of the network node, traffic information including a packet periodicity associated with one or more traffic flows. The one or more processors may be configured to execute the processor-executable instructions and cause the apparatus to transmit an acknowledgement, to the user plane of the network node, that the traffic information has been used.

Some aspects described herein relate to an apparatus for wireless communication at a UE. The apparatus may include one or more memories comprising processor-executable instructions and one or more processors. The one or more processors may be configured to execute the processor-executable instructions and cause the apparatus to receive a control element associated with a DRX cycle performed by the UE. The one or more processors may be configured to execute the processor-executable instructions and cause the apparatus to monitor according to a modified DRX cycle at a time after receiving the control element.

Some aspects described herein relate to an apparatus for wireless communication at a network node. The apparatus may include one or more memories comprising processor-executable instructions and one or more processors. The one or more processors may be configured to execute the processor-executable instructions and cause the apparatus to receive traffic information including a packet periodicity associated with one or more traffic flows. The one or more processors may be configured to execute the processor-executable instructions and cause the apparatus to transmit a control element, associated with a DRX cycle, based at least in part on the traffic information.

Some aspects described herein relate to a non-transitory computer-readable medium that stores a set of instructions for communication by a traffic source or application function. The set of instructions, when executed by one or more processors of the traffic source or application function, may cause the traffic source or application function to determine traffic information including a packet periodicity associated with one or more traffic flows. The set of instructions, when executed by one or more processors of the traffic source or application function, may cause the traffic source or application function to transmit, to a network function, the traffic information including an identifier related to a first packet associated with the packet periodicity.

Some aspects described herein relate to a non-transitory computer-readable medium that stores a set of instructions for communication by a network function. The set of instructions, when executed by one or more processors of the network function, may cause the network function to receive traffic information including a packet periodicity associated with one or more traffic flows and an identifier related to a first packet associated with the packet periodicity. The set of instructions, when executed by one or more processors of the network function, may cause the network function to transmit the traffic information to a network node.

Some aspects described herein relate to a non-transitory computer-readable medium that stores a set of instructions for communication by a UPF. The set of instructions, when executed by one or more processors of the UPF, may cause the UPF to receive traffic information including a packet periodicity associated with one or more traffic flows. The set of instructions, when executed by one or more processors of the UPF, may cause the UPF to transmit the traffic information to a network node.

Some aspects described herein relate to a non-transitory computer-readable medium that stores a set of instructions for communication by a user plane of a network node. The set of instructions, when executed by one or more processors of the user plane, may cause the user plane to receive traffic information including a packet periodicity associated with one or more traffic flows. The set of instructions, when executed by one or more processors of the user plane, may cause the user plane to transmit the traffic information to a control plane of the network node. The set of instructions, when executed by one or more processors of the user plane, may cause the user plane to receive an acknowledgement, from the control plane of the network node, that the traffic information has been used.

Some aspects described herein relate to a non-transitory computer-readable medium that stores a set of instructions for communication by a control plane of a network node. The set of instructions, when executed by one or more processors of the control plane, may cause the control plane to receive, from a user plane of the network node, traffic information including a packet periodicity associated with one or more traffic flows. The set of instructions, when executed by one or more processors of the control plane, may cause the control plane to transmit an acknowledgement, to the user plane of the network node, that the traffic information has been used.

Some aspects described herein relate to a non-transitory computer-readable medium that stores a set of instructions for wireless communication by a UE. The set of instructions, when executed by one or more processors of the UE, may cause the UE to receive a control element associated with a DRX cycle performed by the UE. The set of instructions, when executed by one or more processors of the UE, may cause the UE to monitor according to a modified DRX cycle at a time after receiving the control element.

Some aspects described herein relate to a non-transitory computer-readable medium that stores a set of instructions for wireless communication by a network node. The set of instructions, when executed by one or more processors of the network node, may cause the network node to receive traffic information including a packet periodicity associated with one or more traffic flows. The set of instructions, when executed by one or more processors of the network node, may cause the network node to transmit a control element, associated with a DRX cycle, based at least in part on the traffic information.

Some aspects described herein relate to an apparatus for communication. The apparatus may include means for determining traffic information including a packet periodicity associated with one or more traffic flows. The apparatus may include means for transmitting, to a network function, the traffic information including an identifier related to a first packet associated with the packet periodicity.

Some aspects described herein relate to an apparatus for communication. The apparatus may include means for receiving traffic information including a packet periodicity associated with one or more traffic flows and an identifier related to a first packet associated with the packet periodicity. The apparatus may include means for transmitting the traffic information to a network node.

Some aspects described herein relate to an apparatus for communication. The apparatus may include means for receiving traffic information including a packet periodicity associated with one or more traffic flows. The apparatus may include means for transmitting the traffic information to a network node.

Some aspects described herein relate to an apparatus for communication. The apparatus may include means for receiving traffic information including a packet periodicity associated with one or more traffic flows. The apparatus may include means for transmitting the traffic information to a control plane of the apparatus. The apparatus may include means for receiving an acknowledgement, from the control plane of the apparatus, that the traffic information has been used.

Some aspects described herein relate to an apparatus for communication. The apparatus may include means for receiving, from a user plane of the apparatus, traffic information including a packet periodicity associated with one or more traffic flows. The apparatus may include means for transmitting an acknowledgement, to the user plane of the apparatus, that the traffic information has been used.

Some aspects described herein relate to an apparatus for wireless communication. The apparatus may include means for receiving a control element associated with a DRX cycle performed by the apparatus. The apparatus may include means for monitoring according to a modified DRX cycle at a time after receiving the control element.

Some aspects described herein relate to an apparatus for wireless communication. The apparatus may include means for receiving traffic information including a packet periodicity associated with one or more traffic flows. The apparatus may include means for transmitting a control element, associated with a DRX cycle, based at least in part on the traffic information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example network node in communication with an example user equipment in a wireless network.

FIG. 3 is a diagram illustrating an example disaggregated base station architecture.

FIG. 4 is a diagram of an example disaggregated central unit architecture.

FIG. 5 is a diagram of an example of a core network configured to provide network slicing.

FIGS. 6A and 6B are diagrams illustrating examples associated with indicating a first packet for traffic information.

FIG. 7 is a diagram illustrating an example associated with using traffic information to update a discontinuous reception (DRX) configuration.

FIG. 8 is a diagram illustrating an example associated with updating a DRX configuration using a control element.

FIGS. 9, 10, 11, and 12 are diagrams illustrating example processes associated with traffic pattern information updates.

FIG. 13 is a diagram illustrating an example process associated with traffic pattern information and DRX configuration updates.

FIGS. 14 and 15 are diagrams illustrating example processes associated with DRX configuration updates.

FIGS. 16, 17, 18, and 19 are diagrams of example apparatuses for wireless communication.

FIGS. 20 and 21 are diagrams illustrating examples of implementations of code and circuitry for communications devices.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Some types of traffic, such as extended reality (XR) traffic, are periodic. For example, periodic traffic may be characterized by bursts of packets that are queued according to an approximate periodicity. Therefore, in a wireless network (e.g., a 5G network), transmissions to a user equipment (UE) may similarly be periodic because data arrives at a network node for transmission according to the approximate periodicity.

Various aspects relate generally to indicating a first packet associated with a packet periodicity. Some aspects more specifically relate to indicating the first packet expressly. Alternatively, some aspects more specifically relate to indicating the first packet implicitly. Various aspects relate generally to transferring traffic information, within a user plane, from a core network to a network node. Some aspects more specifically relate to transmitting the traffic information from a user plane function (UPF) of the core network to a user plane of the network node. Additionally, some aspects more specifically relate to transmitting the traffic information from the user plane of the network node to a control plane of the network node. Some aspects more specifically relate to reconfiguring a discontinuous reception (DRX) cycle of a UE according to traffic information. In some aspects, the network node may reconfigure the DRX cycle using a control element.

Particular aspects of the subject matter described in this disclosure can be implemented to realize one or more of the following potential advantages. In some examples, because a first packet associated with a packet periodicity is indicated, the described techniques can be used to align traffic information in a control plane with data packets in a user plane. As a result, computing resources are conserved that otherwise would have been spent in aligning a clock associated with the control plane with a clock associated with the user plane. In some examples, because traffic information is passed from a user plane to a control plane within a network node, the described techniques can be used to reconfigure a DRX cycle of a UE according to the traffic information. As a result, power and processing resources are conserved at the UE that otherwise would have been spent in monitoring when no traffic was queued. In some examples, because the DRX cycle is reconfigured using a control element, the described techniques can be used to reduce overhead associated with reconfiguration of the DRX cycle.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

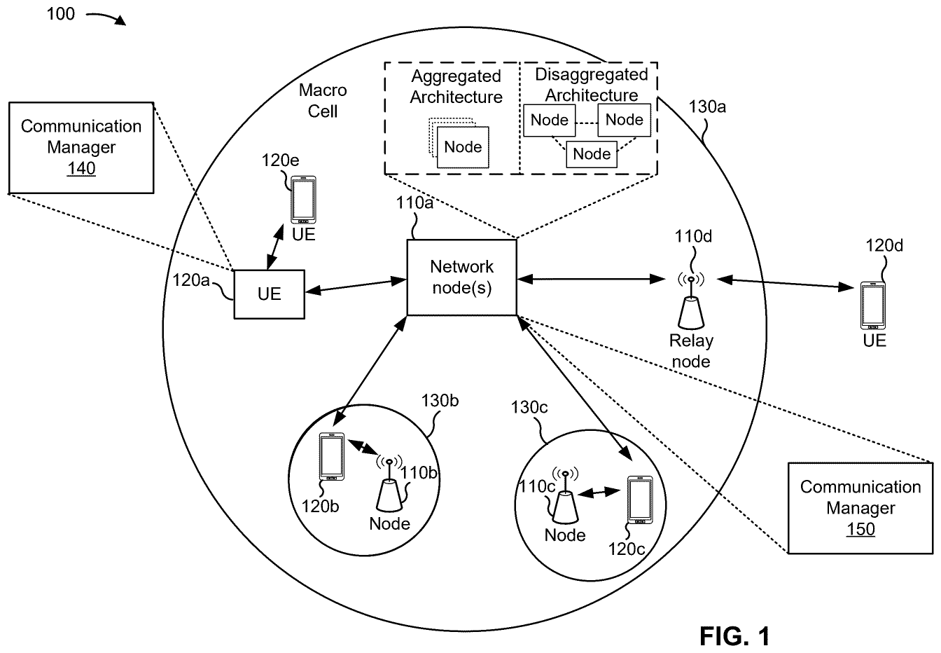

FIG. 1 is a diagram illustrating an example of a wireless communication network 100. The wireless communication network 100 may be or may include elements of a 5G (or NR) network or a 6G network, among other examples. The wireless communication network 100 may include multiple network nodes 110, shown as a network node 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive a control element associated with a DRX cycle performed by the UE and may monitor according to a modified DRX cycle at a time after receiving the control element. Additionally, or alternatively, the communication manager 140 may perform one or more other operations described herein.

In some aspects, the network node 110 may include a communication manager 150. As described in more detail elsewhere herein, the communication manager 150 may receive traffic information including a packet periodicity associated with one or more traffic flows and may transmit a control element, associated with a DRX cycle, based at least in part on the traffic information. Additionally, or alternatively, the communication manager 150 may perform one or more other operations described herein.

As indicated above, FIG. 1 is provided as an example. Other examples may differ from what is described with regard to FIG. 1.

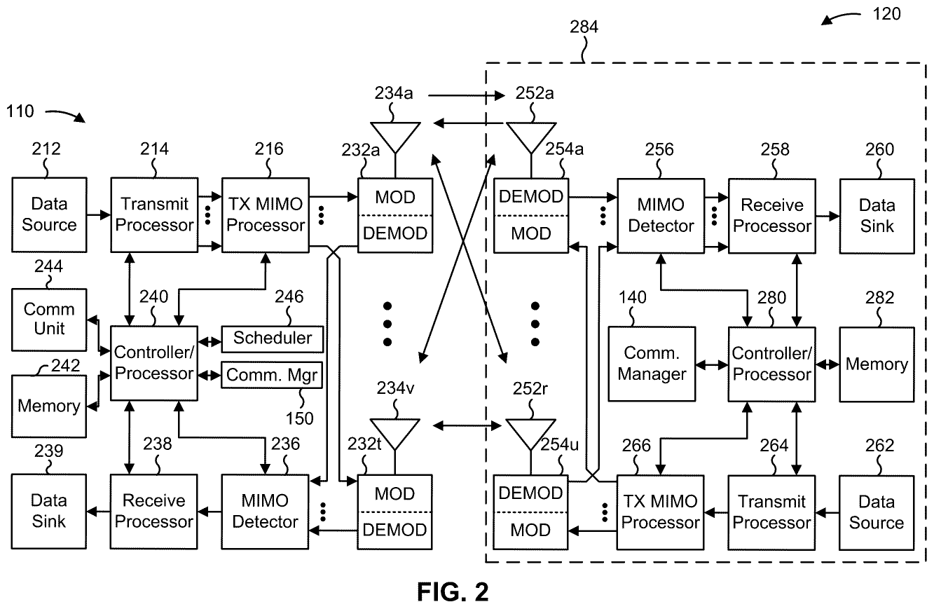

FIG. 2 is a diagram illustrating an example network node 110 in communication with an example UE 120 in a wireless network. As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

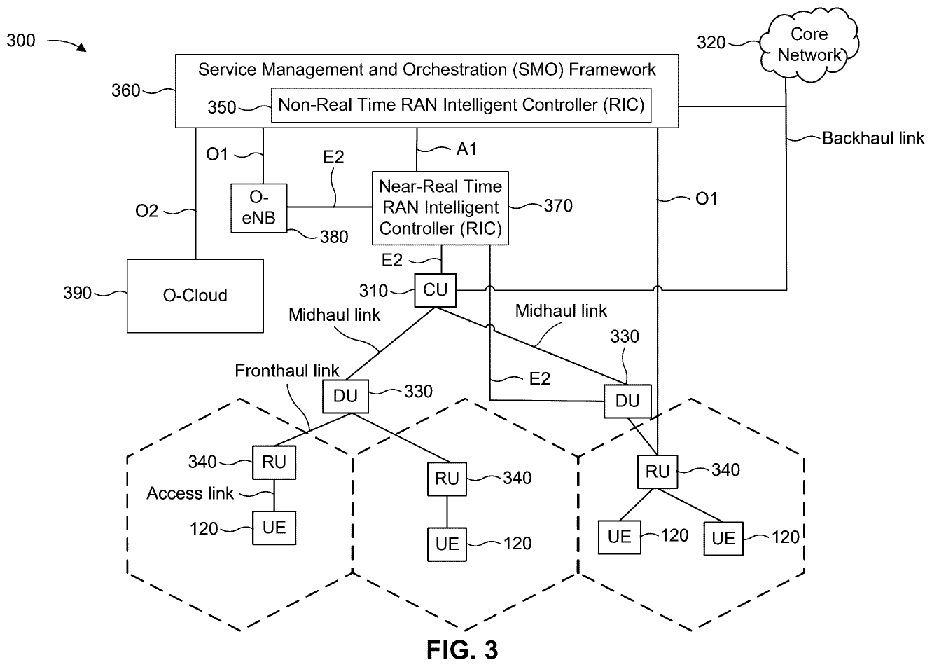

FIG. 3 is a diagram illustrating an example disaggregated base station architecture 300. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

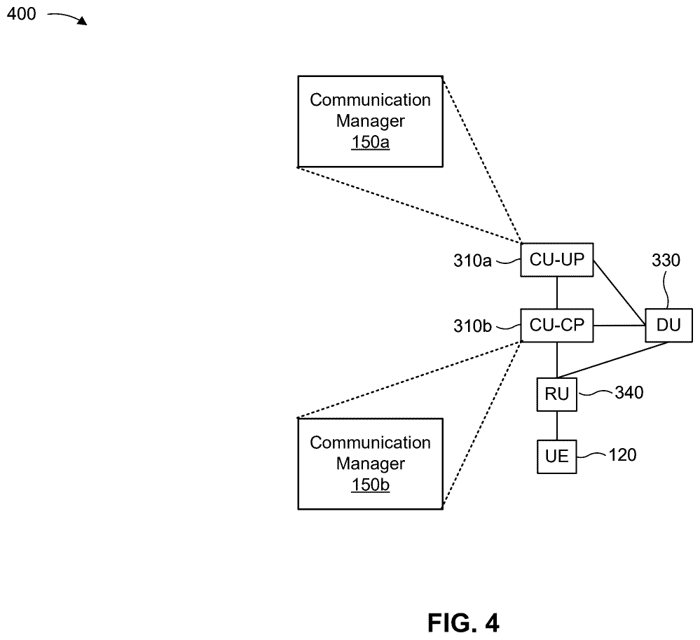

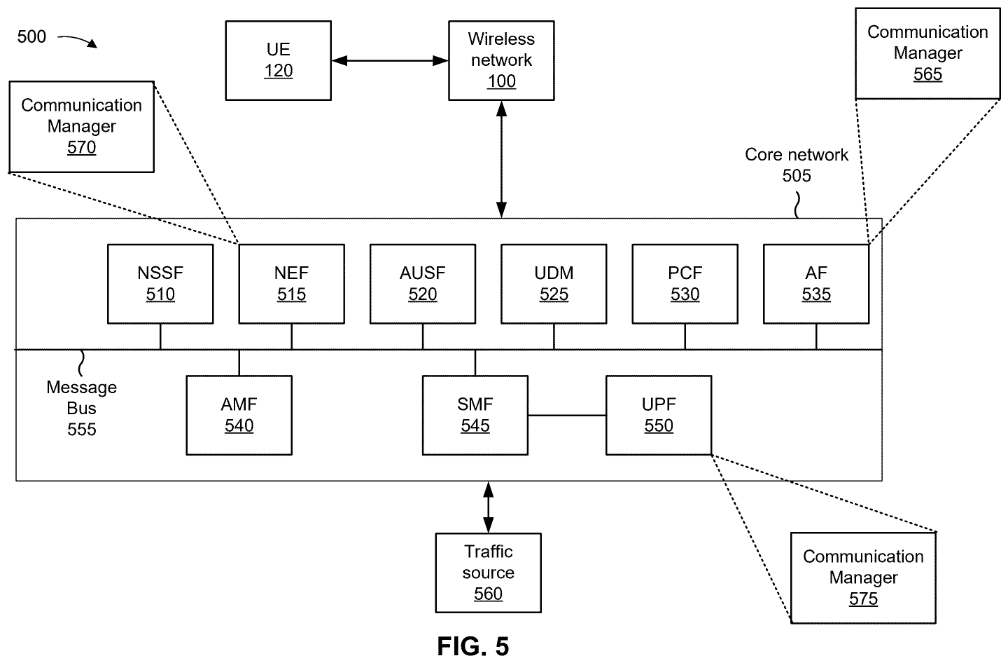

FIG. 4 is a diagram of an example disaggregated CU architecture 400. One or more components of the example disaggregated CU architecture 400 may be, may include, or may be included in one or more network nodes (such one or more network nodes 110). The disaggregated CU architecture 400 may include a user plane CU (CU-UP) 310a that communicates with user plane network functions in a core network (e.g., core network 505 of FIG. 5, as described below) and a control plane CU (CU-CP) 310b that communicates with control plane network functions in the core network. The CU-UP 310a and the CU-CP 310b may communicate with a DU 330 via respective midhaul links, such as via F1 interfaces. Additionally, the CU-UP 310a and CU-CP 310b may communicate with each other via a midhaul link, such as an E1 interface. The DU 330 may communicate with an RU 340 via a fronthaul link. In some aspects, the CU-CP 310b may additionally communicate with the RU 340 via a fronthaul link. The RU 340 may communicate with one or more UEs (e.g., UE 120 in FIG. 4) via an RF access link.

In some aspects, the CU-UP 310a may include a communication manager 150a. As described in more detail elsewhere herein, the communication manager 150a may receive traffic information including a packet periodicity associated with one or more traffic flows, may transmit the traffic information to the CU-CP 310b, and may receive an acknowledgement, from the CU-CP 310b, that the traffic information has been used. Additionally, or alternatively, the communication manager 150a may perform one or more other operations described herein.

In some aspects, the CU-CP 310b may include a communication manager 150b. As described in more detail elsewhere herein, the communication manager 150b may receive, from the CU-UP 310a, traffic information including a packet periodicity associated with one or more traffic flows and may transmit an acknowledgement, to the CU-UP 310b, that the traffic information has been used. Additionally, or alternatively, the communication manager 150b may perform one or more other operations described herein.

As indicated above, FIG. 4 is provided as an example. Other examples may differ from what is described with regard to FIG. 4.

FIG. 5 is a diagram of an example 500 of a core network 505 configured to provide network slicing. As shown in FIG. 5, example 500 may include a UE 120, a wireless network 100, a core network 505, and a traffic source 560. Devices and/or networks of example 500 may interconnect via wired connections, wireless connections, or a combination thereof.

The wireless network 100 may support, for example, a cellular radio access technology (RAT). The wireless network 100 may include one or more network nodes, such as base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network nodes that can support wireless communication for the UE 120. The wireless network 100 may transfer traffic between the UE 120 (e.g., using a cellular RAT), one or more network nodes (e.g., using a wireless interface or a backhaul interface, such as a wired backhaul interface), and/or the core network 505. The wireless network 100 may provide one or more cells that cover geographic areas.

In some aspects, the wireless network 100 may perform scheduling and/or resource management for the UE 120 covered by the wireless network 100 (e.g., the UE 120 covered by a cell provided by the wireless network 100). In some aspects, the wireless network 100 may be controlled or coordinated by a network controller, which may perform load balancing and/or network-level configuration, among other examples. The network controller may communicate with the wireless network 100 via a wireless or wireline backhaul. In some aspects, the wireless network 100 may include a network controller, a self-organizing network (SON) module or component, or a similar module or component. Accordingly, the wireless network 100 may perform network control, scheduling, and/or network management functions (e.g., for uplink, downlink, and/or sidelink communications of the UE 120 covered by the wireless network 100).

In some aspects, the core network 505 may include an example functional architecture in which systems and/or methods described herein may be implemented. For example, the core network 505 may include an example architecture of a 5G next generation (NG) core network included in a 5G wireless telecommunications system. Although the example architecture of the core network 505 shown in FIG. 5 may be an example of a service-based architecture, in some aspects, the core network 505 may be implemented as a reference-point architecture and/or a 4G core network, among other examples.

As shown in FIG. 5, the core network 505 may include a number of functional elements. The functional elements may include, for example, a network slice selection function (NSSF) 510, a network exposure function (NEF) 515, an authentication server function (AUSF) 520, a unified data management (UDM) component 525, a policy control function (PCF) 530, an application function (AF) 535, an access and mobility management function (AMF) 540, a session management function (SMF) 545, and/or a UPF 550, among other examples. These functional elements may be communicatively connected via a message bus 555. Each of the functional elements shown in FIG. 5 may be implemented on one or more devices associated with a wireless telecommunications system. In some implementations, one or more of the functional elements may be implemented on physical devices, such as an access point, a base station, and/or a gateway, among other examples. In some implementations, one or more of the functional elements may be implemented on a computing device of a cloud computing environment.

The NSSF 510 may include one or more devices that select network slice instances for the UE 120. Network slicing is a network architecture model in which logically distinct network slices operate using common network infrastructure. For example, several network slices may operate as isolated end-to-end networks customized to satisfy different target service standards for different types of applications executed, at least in part, by the UE 120 and/or communications to and from the UE 120. Network slicing may efficiently provide communications for different types of services with different service standards.

The NSSF 510 may determine a set of network slice policies to be applied at the wireless communication network 100. For example, the NSSF 510 may apply one or more UE route selection policy (URSP) rules. In some aspects, the NSSF 510 may select a network slice based on a mapping of a data network name (DNN) field included in a route selection description (RSD) to the DNN field included in a traffic descriptor selected by the UE 120. By providing network slicing, the NSSF 510 allows an operator to deploy multiple substantially independent end-to-end networks potentially with the same infrastructure. In some implementations, each slice may be customized for different services.

The NEF 515 may include one or more devices that support exposure of capabilities and/or events in the wireless telecommunications system to help other entities in the wireless telecommunications system discover network services. The AUSF 520 may include one or more devices that act as an authentication server and support the process of authenticating the UE 120 in the wireless telecommunications system.

The UDM 525 may include one or more devices that store user data and profiles in the wireless telecommunications system. In some aspects, the UDM 525 may be used for fixed access and/or mobile access, among other examples, in the core network 505.

The PCF 530 may include one or more devices that provide a policy framework that incorporates network slicing, roaming, packet processing, and/or mobility management, among other examples. In some aspects, the PCF 530 may include one or more URSP rules used by the NSSF 510 to select network slice instances for the UE 120.

The AF 535 may include one or more devices that support application influence on traffic routing, access to the NEF 515, and/or policy control, among other examples. The AMF 540 may include one or more devices that act as a termination point for non-access stratum (NAS) signaling and/or mobility management, among other examples. In some aspects, the AMF may request the NSSF 510 to select network slice instances for the UE 120, e.g., at least partially in response to a request for data service from the UE 120.

The SMF 545 may include one or more devices that support the establishment, modification, and release of communication sessions in the wireless telecommunications system. For example, the SMF 545 may configure traffic steering policies at the UPF 550 and/or enforce user equipment IP address allocation and policies, among other examples. In some aspects, the SMF 545 may provision the network slice instances selected by the NSSF 510 for the UE 120.

The UPF 550 may include one or more devices that serve as an anchor point for intraRAT and/or interRAT mobility. In some aspects, the UPF 550 may apply rules to packets, such as rules pertaining to packet routing, traffic reporting, and/or handling user plane QoS, among other examples.

The message bus 555 may be a logical and/or physical communication structure for communication among the functional elements. Accordingly, the message bus 555 may permit communication between two or more functional elements, whether logically (e.g., using one or more application programming interfaces (APIs), among other examples) and/or physically (e.g., using one or more wired and/or wireless connections).

The traffic source 560 may include a standalone server, a cloud system, or another type of computing device providing data to the UE 120 (via the core network 505 and the wireless network 100) and/or receiving data from the UE 120 (via the wireless network 100 and the core network 505). The traffic source 560 may be associated with an application executed by the UE 120.

In some aspects, the AF 535 may include a communication manager 565. As described in more detail elsewhere herein, the communication manager 565 may determine traffic information including a packet periodicity associated with one or more traffic flows and may transmit, to a network function, the traffic information including an identifier related to a first packet associated with the packet periodicity. Although shown as part of the AF 535, the communication manager 565 may additionally or alternatively be included in the traffic source 560 that communicates with the core network 505. Additionally, or alternatively, the communication manager 565 may perform one or more other operations described herein.

In some aspects, the NEF 515 may include a communication manager 570. As described in more detail elsewhere herein, the communication manager 570 may receive traffic information including a packet periodicity associated with one or more traffic flows and an identifier related to a first packet associated with the packet periodicity and may transmit the traffic information to a network node (e.g., included in the wireless network 100). Although shown as part of the NEF 515, the communication manager 570 may additionally or alternatively be included in the AMF 540 of the core network 505. Additionally, or alternatively, the communication manager 570 may perform one or more other operations described herein.

In some aspects, the UPF 550 may include a communication manager 575. As described in more detail elsewhere herein, the communication manager 575 may receive traffic information including a packet periodicity associated with one or more traffic flows and may transmit the traffic information to a network node (e.g., included in the wireless network 100). Additionally, or alternatively, the communication manager 575 may perform one or more other operations described herein.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of example 500 may perform one or more functions described as being performed by another set of devices of example environment 500.

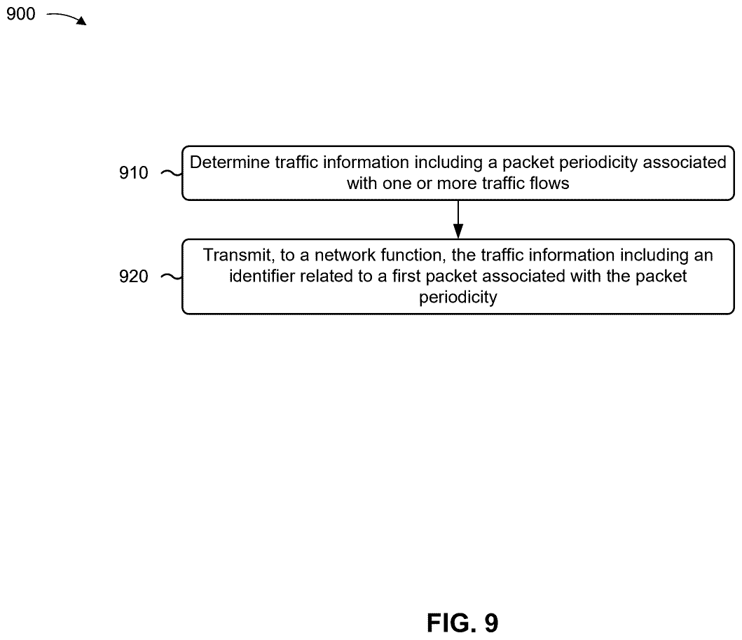

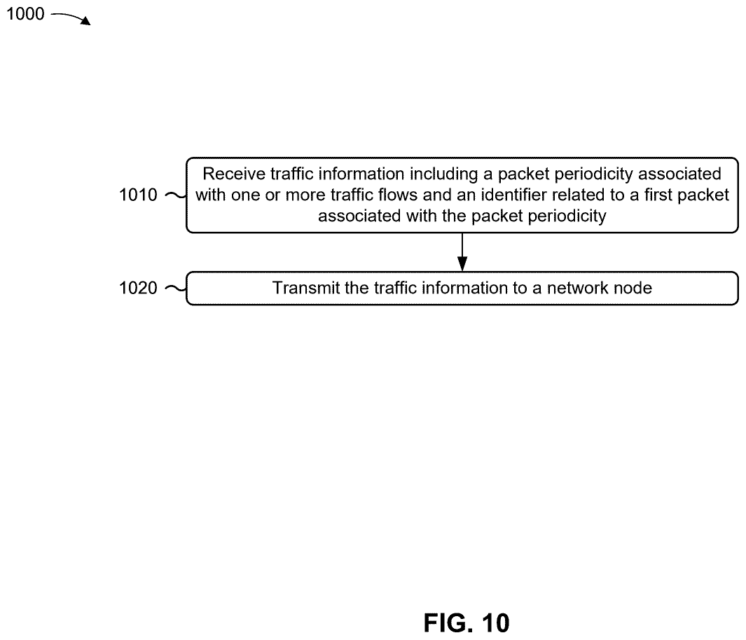

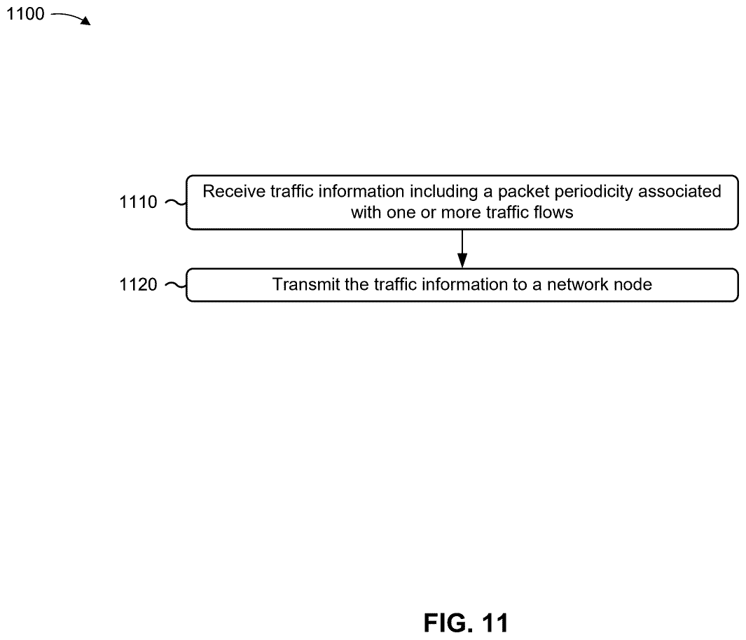

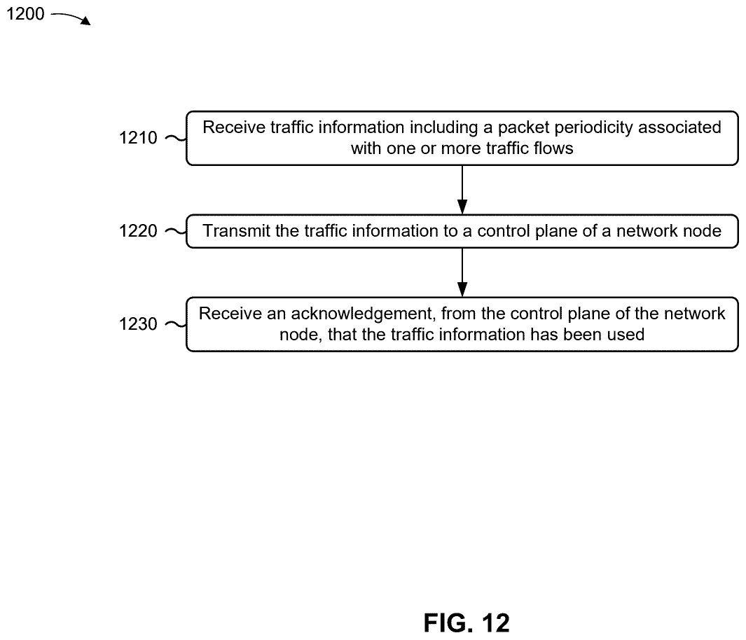

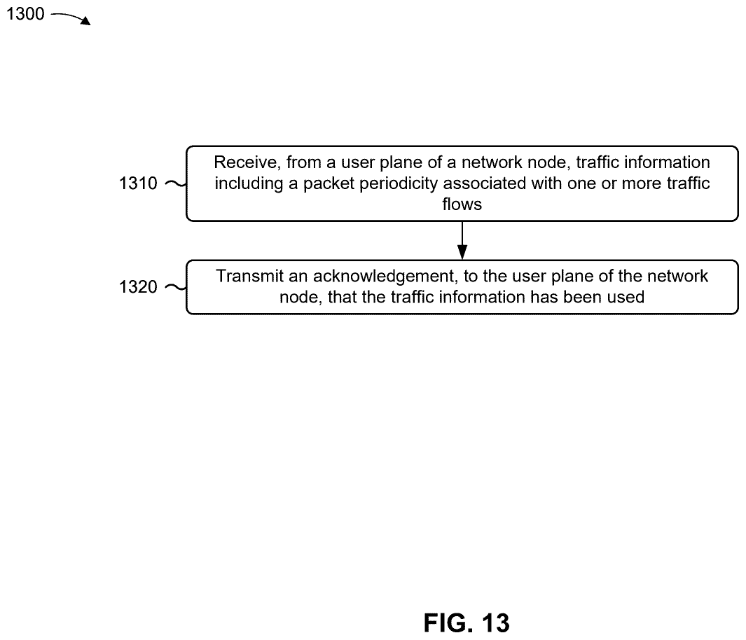

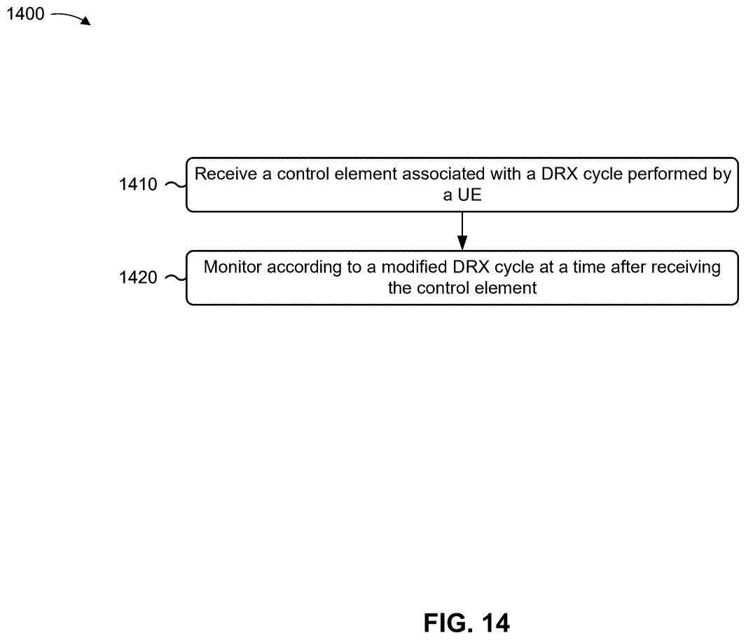

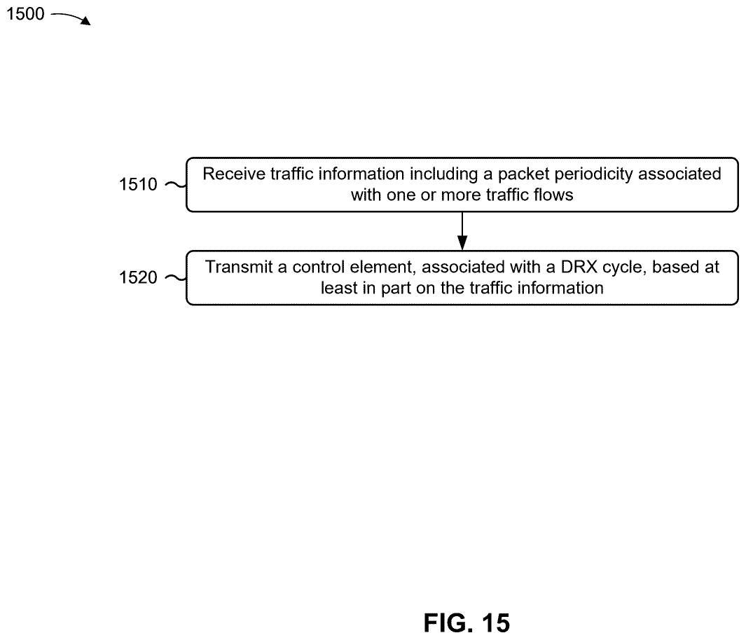

The network node 110, the controller/processor 240 of the network node 110, the UE 120, the controller/processor 280 of the UE 120, the CU 310 (whether the CU-UP 310a and/or the CU-CP 310b), the DU 330, the RU 340, a network function in the core network 505, or any other component(s) of FIGS. 1-5 may implement one or more techniques or perform one or more operations associated with updating traffic pattern information and DRX configurations, as described in more detail elsewhere herein. For example, the controller/processor 240 of the network node 110, the controller/processor 280 of the UE 120, any other component(s) of FIG. 2, the CU 310 (whether the CU-UP 310a and/or the CU-CP 310b), the DU 330, the RU 340, or a network function in the core network 505 may perform or direct operations of, for example, process 900 of FIG. 9, process 1000 of FIG. 10, process 1100 of FIG. 11, process 1200 of FIG. 12, process 1300 of FIG. 13, process 1400 of FIG. 14, process 1500 of FIG. 15, or other processes as described herein (alone or in conjunction with one or more other processors). The memory 242 may store data and program codes for the network node 110, the network node 110, the CU 310 (whether the CU-UP 310a and/or the CU-CP 310b), the DU 330, the RU 340, or a network function in the core network 505. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310 (whether the CU-UP 310a and/or the CU-CP 310b), the DU 330, the RU 340, or a network function in the core network 505, may cause the one or more processors to perform process 900 of FIG. 9, process 1000 of FIG. 10, process 1100 of FIG. 11, process 1200 of FIG. 12, process 1300 of FIG. 13, process 1400 of FIG. 14, process 1500 of FIG. 15, or other processes as described herein. In some examples, executing instructions may include running the instructions, converting the instructions, compiling the instructions, and/or interpreting the instructions, among other examples.

In some aspects, the traffic source 560 and/or the AF 535 may include means for determining traffic information including a packet periodicity associated with one or more traffic flows and/or means for transmitting, to a network function, the traffic information including an identifier related to a first packet associated with the packet periodicity. In some aspects, the means for the traffic source and/or the AF to perform operations described herein may include, for example, one or more of communication manager 565, transmit processor 214, TX MIMO processor 216, modem 232, antenna 234, MIMO detector 236, receive processor 238, controller/processor 240, memory 242, or scheduler 246.

In some aspects, a network function (e.g., the NEF 515 and/or the AMF 540) may include means for receiving traffic information including a packet periodicity associated with one or more traffic flows and an identifier related to a first packet associated with the packet periodicity and/or means for transmitting the traffic information to a network node. In some aspects, the means for the network function to perform operations described herein may include, for example, one or more of communication manager 570, transmit processor 214, TX MIMO processor 216, modem 232, antenna 234, MIMO detector 236, receive processor 238, controller/processor 240, memory 242, or scheduler 246.

In some aspects, the UPF 550 may include means for receiving traffic information including a packet periodicity associated with one or more traffic flows; and/or means for transmitting the traffic information to a network node. In some aspects, the means for the UPF to perform operations described herein may include, for example, one or more of communication manager 575, transmit processor 214, TX MIMO processor 216, modem 232, antenna 234, MIMO detector 236, receive processor 238, controller/processor 240, memory 242, or scheduler 246.

In some aspects, a user plane in a network node (e.g., CU-UP 310a) may include means for receiving traffic information including a packet periodicity associated with one or more traffic flows; means for transmitting the traffic information to a control plane of the network node; and/or means for receiving an acknowledgement, from the control plane of the network node, that the traffic information has been used. In some aspects, the means for the user plane to perform operations described herein may include, for example, one or more of communication manager 150a, transmit processor 214, TX MIMO processor 216, modem 232, antenna 234, MIMO detector 236, receive processor 238, controller/processor 240, memory 242, or scheduler 246.

In some aspects, a control plane in a network node (e.g., CU-CP 310b) includes means for receiving, from a user plane of the network node, traffic information including a packet periodicity associated with one or more traffic flows; and/or means for transmitting an acknowledgement, to the user plane of the network node, that the traffic information has been used. In some aspects, the means for the control plane to perform operations described herein may include, for example, one or more of communication manager 150b, transmit processor 214, TX MIMO processor 216, modem 232, antenna 234, MIMO detector 236, receive processor 238, controller/processor 240, memory 242, or scheduler 246.

In some aspects, the UE 120 may include means for receiving a control element associated with a DRX cycle performed by the UE 120 and/or means for monitoring according to a modified DRX cycle at a time after receiving the control element. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 may include means for receiving traffic information including a packet periodicity associated with one or more traffic flows and/or means for transmitting a control element, associated with a DRX cycle, based at least in part on the traffic information. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 5 is provided as an example. Other examples may differ from what is described with regard to FIG. 5.

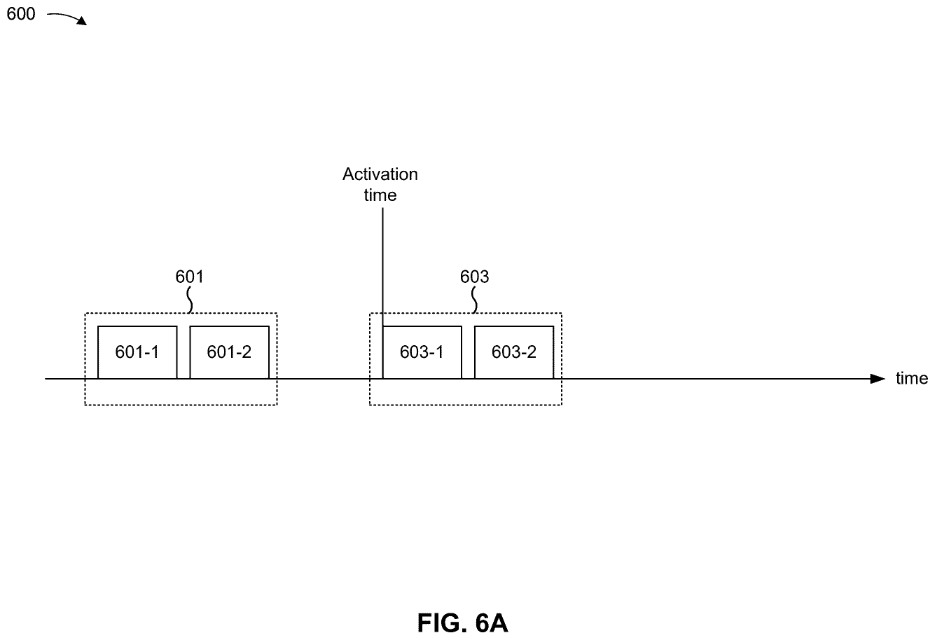

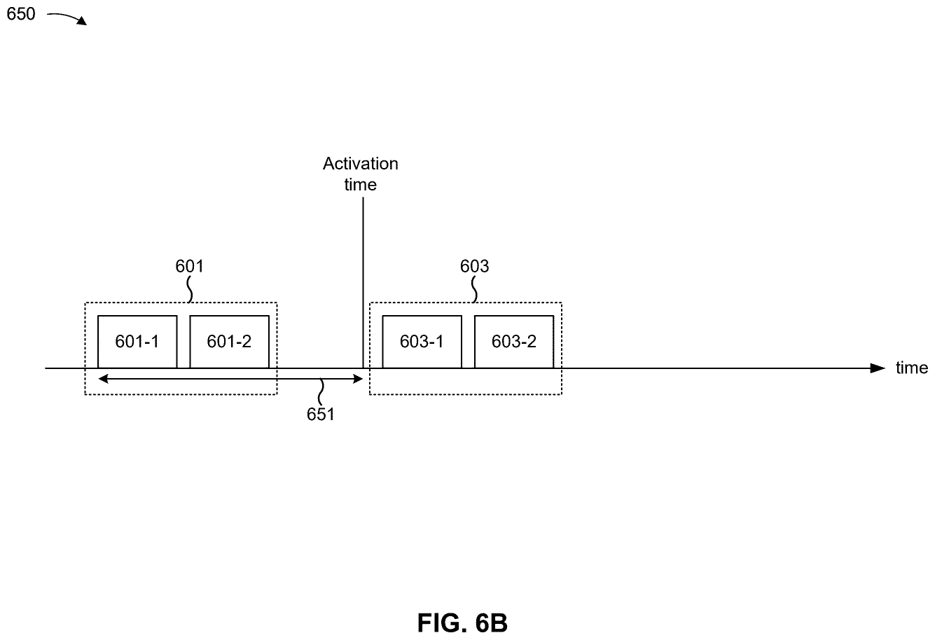

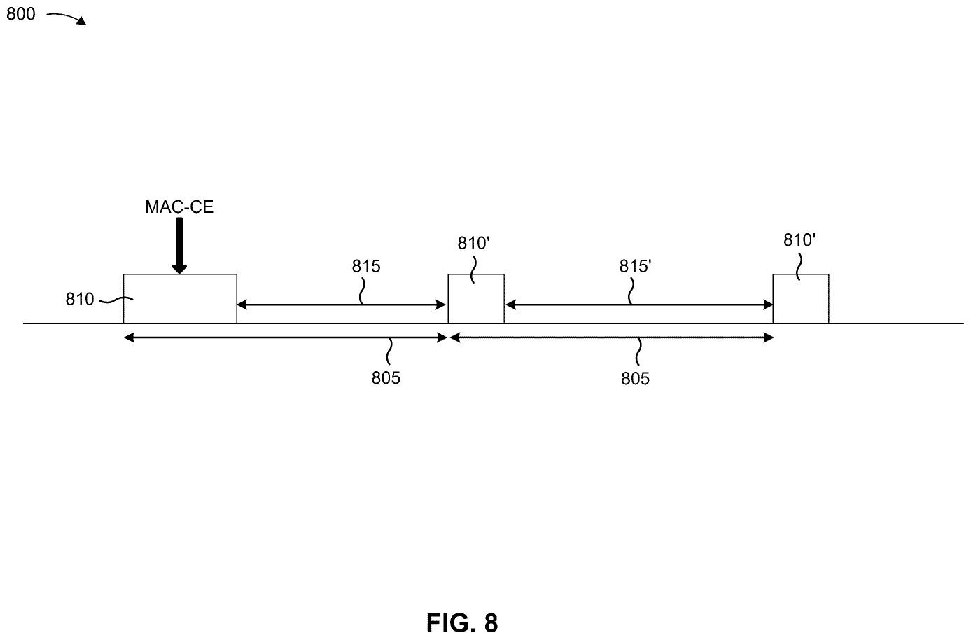

FIGS. 6A and 6B are diagrams illustrating examples 600 and 650, respectively, associated with indicating a first packet for traffic information. As shown in FIG. 6A, the example 600 includes a first set of packets 601 (queued for transmission to a UE 120) may include a packet 601-1 and a packet 601-2. The packets 601-1 and 601-2 may include real time protocol (RTP) packets or QUIC packets, among other examples. Traffic information (e.g., a packet periodicity associated with one or more traffic flows and/or a jitter associated with the traffic flow(s)) may apply starting at a second set of packets 603 (queued for transmission to a UE 120) that includes a packet 603-1 and a packet 603-2. Therefore, in order to indicate an activation time starting with the packet 603-1, a traffic source 560 (providing the sets of packets 601 and 603) and/or an AF 535 (associated with the UE 120) may indicate the packet 603-1 with the traffic information. For example, the traffic source 560 and/or the AF 535 may include an identifier that indicates the packet 603-1, such as a protocol data unit (PDU) set sequence number (PSSN) or a QUIC packet number, among other examples. A network function (e.g., an NEF 515 and/or an AMF 540) may receive the traffic information (with the identifier of the packet 603-1) and transmit the traffic information (with the identifier) to a network node 110 (e.g., to use for updating a DRX configuration, as described in connection with FIG. 8). In response to the identifier of the packet 603-1, the network function and/or the network node 110 may activate the traffic information upon receiving the packet 603-1.

In some aspects, the traffic information may further include an identifier associated with the traffic flow(s). For example, the traffic information may include a source Internet protocol (IP) address (e.g., associated with the traffic source 560) and/or a destination IP address (e.g., associated with the UE 120). Therefore, the traffic information may apply to a single traffic flow (e.g., from the traffic source 560 to the UE 120) or to multiple traffic flows (e.g., all traffic to the UE 120). In another example, the traffic information may include an IP 5-tuple (e.g., including a source IP address, a destination IP address, a source port number, a destination port number, and a protocol number). Therefore, the traffic information may apply to traffic flows in a single connection or network session with the UE 120.

The example 650 of FIG. 6B is similar to the example 600 of FIG. 6A but includes a duration 651 indicated by the traffic source 560 and/or the AF 535. Therefore, in FIG. 6B, in order to indicate an activation time for the traffic information, the traffic source 560 and/or the AF 535 may indicate the packet 601-1 along with the duration 651. A network function (e.g., an NEF 515 and/or an AMF 540) may receive the traffic information (with the identifier of the packet 601-1 and the duration 651) and transmit the traffic information (with the identifier and the duration) to a network node 110 (e.g., to use for updating a DRX configuration, as described in connection with FIG. 8). In response to the identifier of the packet 601-1 and the duration 651, the network function and/or the network node 110 may activate the traffic information upon passing of the duration 651 after receiving the packet 601-1.

By using techniques as described in connection with FIGS. 6A-6B, a first packet associated with the traffic information is indicated. As a result, the traffic information may be activated in a control plane in alignment with arrival of data packets in a user plane even when a clock of the user plane is not synchronized with a clock of the control plane.

As indicated above, FIGS. 6A and 6B are provided as examples. Other examples may differ from what is described with respect to FIGS. 6A and 6B.

In one example, information may be added to time sensitive communications assistance information (TSCAI), as defined in 3GPP specifications, to indicate a traffic pattern. In some aspects, an activation packet identifier is included. The identifier may indicate a packet at which the traffic pattern is to be activated; if a time to activation is also indicated, the activation may be delayed by the indicated time after the packet. For example, the time to activation may indicate a time to elapse after an arrival of the packet.

Similarly, information may be added to a TSCAI information element (IE), as defined in 3GPP specifications, to indicate the traffic pattern. In some aspects, an activation packet identifier is included. For example, the identifier may be an integer type (e.g., an integer from 0 to 1023). The identifier may represent a PSSN in a PDU Set Marking RTP header extension of an RTP packet. In some aspects, a time to activation may also be added. For example, the time to activation may be an integer type (e.g., an integer from 0 to 16777216). The time to activation may represent a time to elapse since an arrival of a packet identified by the activation packet identifier. In one example, the time to activation is 24 bits long and has a unit of microseconds.

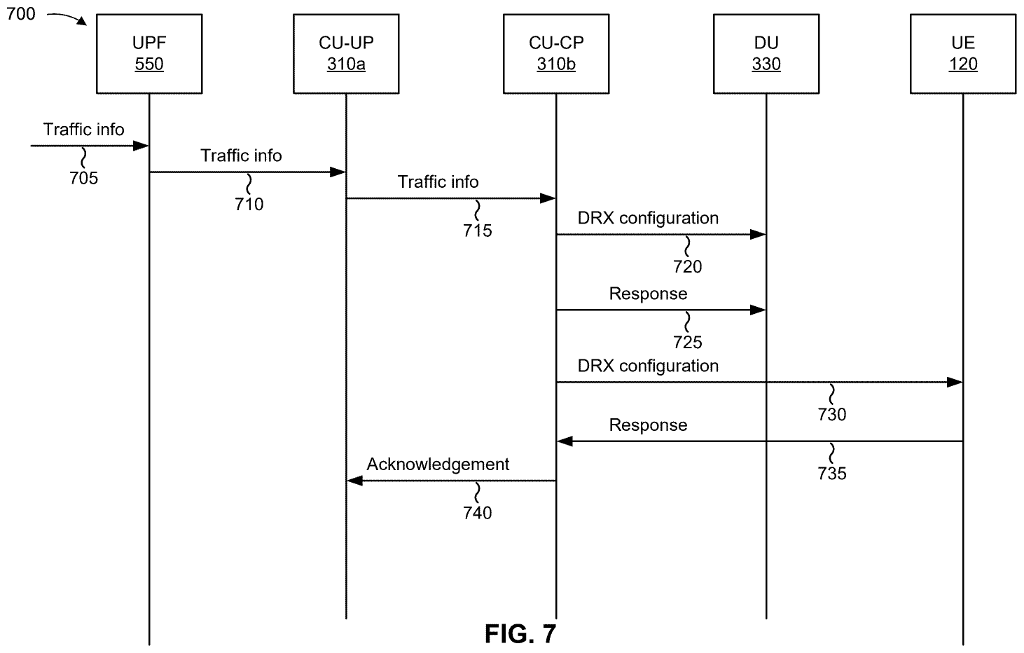

FIG. 7 is a diagram illustrating an example 700 associated with using traffic information to update a DRX configuration. As shown in FIG. 7, traffic information may be received in a user plane of a core network 505 rather than in a control plane, as described in connection with FIGS. 6A-6B. Accordingly, the example 700 includes a UPF 550 that communicates with a CU-UP 310a (of a network node 110) on a backhaul link. Additionally, the example 700 includes a CU-CP 310b (of the network node 110) that communicates with a DU 330 (of the network node 110) on a midhaul link. The CU-CP 310a and the DU 330 may communicate OTA with a UE 120 (e.g., via an RU 340, which is not shown in FIG. 7).

As shown by reference number 705, the UPF 550 may receive (e.g., in an incoming data packet) traffic information. The traffic information may include a packet periodicity associated with one or more traffic flows and/or a jitter associated with the traffic flow(s). Additionally, the traffic information may indicate an activation time associated with the packet periodicity. The activation time may include an absolute time (e.g., a universal coordinated time (UTC) value) or a relative time (e.g., an indication of a first packet or an earlier packet and a duration, similarly as described in connection with FIGS. 6A-6B).

The UPF 550 may extract the traffic information from an RTP packet header extension or a QUIC packet header, among other examples. Additionally, the UPF 550 may encode the traffic information in one or more fields of a general packet radio service (GPRS) tunnelling protocol (GTP) header. The GTP header may be a user plane GTP (GTP-U) header. As shown by reference number 710, the UPF 550 may transmit, and the CU-UP 310a may receive, the traffic information (e.g., in the GTP header).

The CU-UP 310a may extract the traffic information from the GTP header. Additionally, the CU-UP 310a may encode the traffic information in an E1 application protocol (E1-AP) message. As shown by reference number 715, the CU-UP 310a may transmit, and the CU-CP 310b may receive, the traffic information (e.g., in the E1-AP message).

The CU-CP 310b may extract the traffic information from the E1-AP message. The CU-CP 310b may determine a DRX configuration based at least in part on the traffic information. For example, the CU-CP 310b may determine a periodicity for the DRX configuration to equal the packet periodicity in the traffic information. Additionally, or alternatively, the CU-CP 310b may determine an ON duration for the DRX configuration equal to a packet burst duration plus a jitter in the traffic information. As shown by reference number 720, the CU-CP 310b may transmit, and the DU 330 may receive, the DRX configuration. For example, the CU-CP 310b may transmit, and the DU 330 may receive, an F1 application protocol (F1-AP) message (e.g., an F1AP UE Context Modification Request message, as defined in 3GPP specifications) that includes the DRX configuration. In some aspects, as shown by reference number 725, the DU 330 may transmit, and the CU-CP 310b may receive, a response to the DRX configuration. For example, the DU 330 may transmit, and the CU-CP 310b may receive, an F1-AP message (e.g., an F1AP UE Context Modification Response message, as defined in 3GPP specifications) to confirm receipt of the DRX configuration. Therefore, the DU 330 may transmit data to the UE 120 according to the DRX configuration.

Additionally, as shown by reference number 730, the CU-CP 310b may transmit, and the UE 120 may receive, the DRX configuration. For example, the CU-CP 310b may transmit, and the UE 120 may receive, RRC Reconfiguration Request message, as defined in 3GPP specifications, that includes the DRX configuration. In some aspects, as shown by reference number 735, the UE 120 may transmit, and the CU-CP 310b may receive, a response to the DRX configuration. For example, the UE 120 may transmit, and the CU-CP 310b may receive, an RRC Reconfiguration Complete message, as defined in 3GPP specifications, to confirm receipt of the DRX configuration. Therefore, the UE 120 may monitor for data (from the DU 330) according to the DRX configuration.

As shown by reference number 740, the CU-CP 310b may transmit, and the CU-UP 310a may receive, an acknowledgement that the traffic information has been used. For example, the acknowledgement may be included in an E1-AP message. In some aspects, the CU-CP 310b may transmit the acknowledgement in response to transmitting the DRX configuration (e.g., to the DU 330 and/or to the UE 120).

By using techniques as described in connection with FIG. 7, because the traffic information is passed from the CU-UP 310a to the CU-CP 310b, the described techniques can be used to determine the DRX configuration for the UE 120 according to the traffic information. As a result, power and processing resources are conserved at the UE 120 that otherwise would have been spent monitoring when traffic is not flowing to the UE 120.

As indicated above, FIG. 7 is provided as an example. Other examples may differ from what is described with respect to FIG. 7.

FIG. 8 is a diagram illustrating an example 800 associated with updating a DRX configuration using a MAC-CE. As shown in FIG. 8, a UE 120 may be configured with a DRX configuration. The DRX configuration may have a periodicity 805 and an ON duration 810 that repeats according to the periodicity 805. Accordingly, the UE 120 may conserve power and processing resources between ON durations (e.g., according to a sleep time 815 associated with the DRX configuration). For example, the UE 120 may refrain from monitoring a control channel for scheduling information during the sleep time 815.

As further shown in FIG. 8, a network node 110 may transmit a control element (e.g., a MAC-CE) to the UE 120 during the ON duration 810. The control element may include a DRX Command MAC-CE or a Long DRX Command MAC-CE, as defined in 3GPP specifications. The network node 110 may receive traffic information (e.g., as described above in connection with FIGS. 6A, 6B, and 7) and may determine to transmit the control element based at least in part on the traffic information. The UE 120 may terminate the ON duration 810 in response to the control element and enter the sleep time 815 early. Accordingly, in one example, the network node 110 may determine to transmit the control element in response to the traffic information indicating shorter bursts of data than the ON duration 810.

In some aspects, the network node 110 may transmit, and the UE 120 may receive, an RRC reconfiguration indicating a modified DRX cycle at a time after the control element. For example, the network node 110 may transmit, and the UE 120 may receive, the RRC reconfiguration in an ON duration 810 subsequent to the control element. In one example, the network node 110 may determine that the traffic information is persistent, may determine that multiple applications (executed by the UE 120) align with the traffic information, and/or may determine that a current application (executed by the UE 120) has aligned with the traffic information. Therefore, the network node 110 may transmit the RRC reconfiguration in response to the determination(s). As a result, the UE 120 may monitor according to the modified DRX cycle.

In order to conserve power and processing resources consumed in transmitting an RRC reconfiguration, the network node 110 may instead use the control element to generate the modified DRX cycle. For example, as shown in FIG. 8, the UE 120 may determine a shortened ON duration 810′ and a lengthened sleep time 815′ based at least in part on the control element. The UE 120 may determine the shorted ON duration 810′ as the ON duration 810 shortened by a reception time of the control element (relative to a start of the ON duration 810). Additionally, the UE 120 may determine the lengthened sleep time 815′ by holding the periodicity 805 constant.

As indicated above, FIG. 8 is provided as an example. Other examples may differ from what is described with respect to FIG. 8.

FIG. 9 is a diagram illustrating an example process 900 performed, for example, at a traffic source or application function or an apparatus of a traffic source or AF. Example process 900 is an example where the apparatus or the traffic source or AF (e.g., traffic source 560 or AF 535) performs operations associated with traffic pattern information updates.

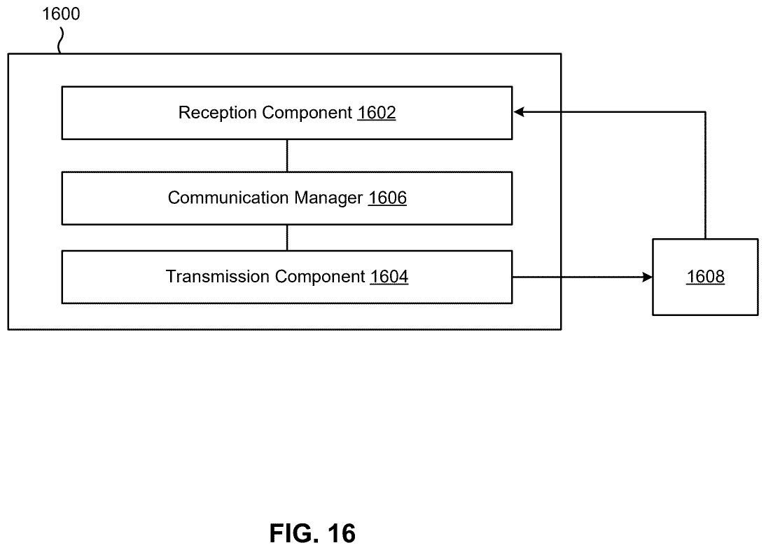

As shown in FIG. 9, in some aspects, process 900 may include determining traffic information including a packet periodicity associated with one or more traffic flows (block 910). For example, the traffic source or application function (e.g., using communication manager 1606, depicted in FIG. 16) may determine traffic information including a packet periodicity associated with one or more traffic flows, as described herein.

As further shown in FIG. 9, in some aspects, process 900 may include transmitting, to a network function, the traffic information including an identifier related to a first packet associated with the packet periodicity (block 920). For example, the traffic source or application function (e.g., using transmission component 1604 and/or communication manager 1606, depicted in FIG. 16) may transmit, to a network function, the traffic information including an identifier related to a first packet associated with the packet periodicity, as described herein.

Process 900 may include additional aspects, such as any single aspect or any combination of aspects described below and/or in connection with one or more other processes described elsewhere herein.

In a first aspect, the identifier is included in an RTP packet header or an RTP packet header extension.

In a second aspect, alone or in combination with the first aspect, the identifier includes a PSSN.

In a third aspect, alone or in combination with one or more of the first and second aspects, the identifier is included in a QUIC packet field.

In a fourth aspect, alone or in combination with one or more of the first through third aspects, the identifier includes a packet number.

In a fifth aspect, alone or in combination with one or more of the first through fourth aspects, the identifier indicates the first packet, and the traffic information is activated at the first packet.

In a sixth aspect, alone or in combination with one or more of the first through fifth aspects, the identifier indicates an earlier packet, the identifier indicates a duration between the earlier packet and the first packet, and the traffic information is activated after the duration has passed.

In a seventh aspect, alone or in combination with one or more of the first through sixth aspects, the traffic information includes a jitter associated with the one or more traffic flows.

In an eighth aspect, alone or in combination with one or more of the first through seventh aspects, the traffic information includes an identifier associated with the one or more traffic flows.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network function or an apparatus of a network function. Example process 1000 is an example where the apparatus or the network function (e.g., NEF 515 or AMF 540) performs operations associated with traffic pattern information updates.

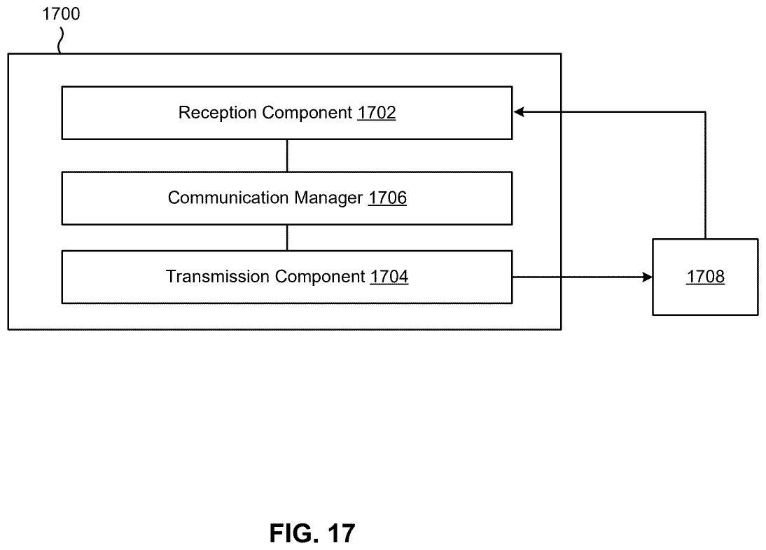

As shown in FIG. 10, in some aspects, process 1000 may include receiving traffic information including a packet periodicity associated with one or more traffic flows and an identifier related to a first packet associated with the packet periodicity (block 1010). For example, the network function (e.g., using reception component 1702 and/or communication manager 1706, depicted in FIG. 17) may receive traffic information including a packet periodicity associated with one or more traffic flows and an identifier related to a first packet associated with the packet periodicity, as described herein.

As further shown in FIG. 10, in some aspects, process 1000 may include transmitting the traffic information to a network node (block 1020). For example, the network function (e.g., using transmission component 1704 and/or communication manager 1706, depicted in FIG. 17) may transmit the traffic information to a network node, as described herein.

Process 1000 may include additional aspects, such as any single aspect or any combination of aspects described below and/or in connection with one or more other processes described elsewhere herein.

In a first aspect, the identifier is included in an RTP packet header or an RTP packet header extension.

In a second aspect, alone or in combination with the first aspect, the identifier includes a PSSN.

In a third aspect, alone or in combination with one or more of the first and second aspects, the identifier is included in a QUIC packet field.

In a fourth aspect, alone or in combination with one or more of the first through third aspects, the identifier includes a packet number.

In a fifth aspect, alone or in combination with one or more of the first through fourth aspects, the identifier indicates the first packet, and the traffic information is activated at the first packet.

In a sixth aspect, alone or in combination with one or more of the first through fifth aspects, the identifier indicates an earlier packet, the identifier indicates a duration between the earlier packet and the first packet, and the traffic information is activated after the duration has passed.

In a seventh aspect, alone or in combination with one or more of the first through sixth aspects, the traffic information includes a jitter associated with the one or more traffic flows.

In an eighth aspect, alone or in combination with one or more of the first through seventh aspects, the traffic information includes an identifier associated with the one or more traffic flows.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a UPF or an apparatus of a UPF. Example process 1100 is an example where the apparatus or the UPF (e.g., UPF 550) performs operations associated with traffic pattern information updates.

As shown in FIG. 11, in some aspects, process 1100 may include receiving traffic information including a packet periodicity associated with one or more traffic flows (block 1110). For example, the UPF (e.g., using reception component 1702 and/or communication manager 1706, depicted in FIG. 17) may receive traffic information including a packet periodicity associated with one or more traffic flows, as described herein.

As further shown in FIG. 11, in some aspects, process 1100 may include transmitting the traffic information to a network node (block 1120). For example, the UPF (e.g., using transmission component 1704 and/or communication manager 1706, depicted in FIG. 17) may transmit the traffic information to a network node, as described herein.

Process 1100 may include additional aspects, such as any single aspect or any combination of aspects described below and/or in connection with one or more other processes described elsewhere herein.

In a first aspect, the traffic information is included in an RTP packet header extension or a QUIC packet header.

In a second aspect, alone or in combination with the first aspect, the traffic information includes a jitter associated with the one or more traffic flows.

In a third aspect, alone or in combination with one or more of the first and second aspects, the traffic information includes an activation time associated with the packet periodicity.

In a fourth aspect, alone or in combination with one or more of the first through third aspects, transmitting the traffic information to the network node includes encoding the traffic information in one or more fields of a GTP header.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a user plane of a network node or an apparatus of a user plane of a network node. Example process 1200 is an example where the apparatus or the user plane of the network node (e.g., CU-UP 310a) performs operations associated with traffic pattern information updates.

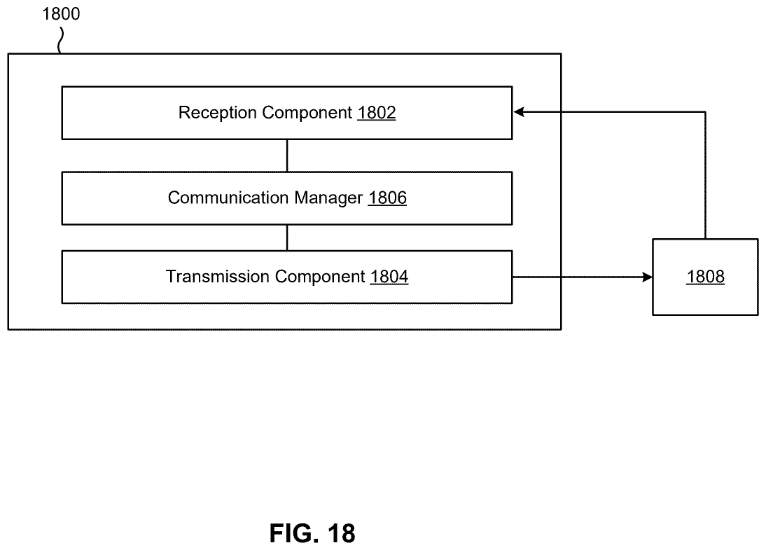

As shown in FIG. 12, in some aspects, process 1200 may include receiving traffic information including a packet periodicity associated with one or more traffic flows (block 1210). For example, the user plane of the network node (e.g., using reception component 1802 and/or communication manager 1806, depicted in FIG. 18) may receive traffic information including a packet periodicity associated with one or more traffic flows, as described herein.

As further shown in FIG. 12, in some aspects, process 1200 may include transmitting the traffic information to a control plane of a network node (block 1220). For example, the user plane of the network node (e.g., using transmission component 1804 and/or communication manager 1806, depicted in FIG. 18) may transmit the traffic information to a control plane of the network node, as described herein.

As further shown in FIG. 12, in some aspects, process 1200 may include receiving an acknowledgement, from the control plane of the network node, that the traffic information has been used (block 1230). For example, the user plane of the network node (e.g., using reception component 1802 and/or communication manager 1806) may receive an acknowledgement, from the control plane of the network node, that the traffic information has been used, as described herein.

Process 1200 may include additional aspects, such as any single aspect or any combination of aspects described below and/or in connection with one or more other processes described elsewhere herein.

In a first aspect, the traffic information is included in a GTP header.

In a second aspect, alone or in combination with the first aspect, transmitting the traffic information to the control plane of the network node includes transmitting an E1-AP message including the traffic information.

In a third aspect, alone or in combination with one or more of the first and second aspects, receiving the acknowledgement from the control plane of the network node includes receiving an E1-AP message including the acknowledgement.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a control plane of a network node or an apparatus of a control plane of a network node. Example process 1300 is an example where the apparatus or the control plane (e.g., CU-CP 310b) performs operations associated with traffic pattern information and DRX configuration updates.

As shown in FIG. 13, in some aspects, process 1300 may include receiving, from a user plane of a network node, traffic information including a packet periodicity associated with one or more traffic flows (block 1310). For example, the control plane of the network node (e.g., using reception component 1802 and/or communication manager 1806, depicted in FIG. 18) may receive, from a user plane of the network node, traffic information including a packet periodicity associated with one or more traffic flows, as described herein.

As further shown in FIG. 13, in some aspects, process 1300 may include transmitting an acknowledgement, to the user plane of the network node, that the traffic information has been used (block 1320). For example, the control plane of the network node (e.g., using transmission component 1804 and/or communication manager 1806, depicted in FIG. 18) may transmit an acknowledgement, to the user plane of the network node, that the traffic information has been used, as described herein.

Process 1300 may include additional aspects, such as any single aspect or any combination of aspects described below and/or in connection with one or more other processes described elsewhere herein.

In a first aspect, the traffic information is included in an E1-AP message.

In a second aspect, alone or in combination with the first aspect, the acknowledgement is included in an E1-AP message.

In a third aspect, alone or in combination with one or more of the first and second aspects, process 1300 includes transmitting (e.g., using transmission component 1804 and/or communication manager 1806) a DRX configuration based at least in part on the traffic information.

In a fourth aspect, alone or in combination with one or more of the first through third aspects, the DRX configuration is included in an F1-AP message to the control plane of the network node.

In a fifth aspect, alone or in combination with one or more of the first through fourth aspects, the DRX configuration is included in an RRC message to a UE.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a UE or an apparatus of a UE. Example process 1400 is an example where the apparatus or the UE (e.g., UE 120) performs operations associated with DRX configuration updates.

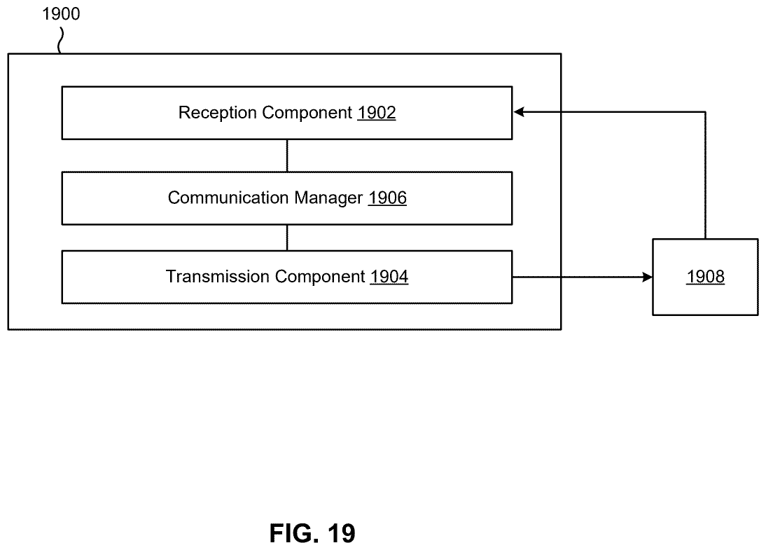

As shown in FIG. 14, in some aspects, process 1400 may include receiving a control element associated with a DRX cycle performed by a UE (block 1410). For example, the UE (e.g., using reception component 1902 and/or communication manager 1906, depicted in FIG. 19) may receive a control element associated with a DRX cycle performed by the UE, as described herein.

As further shown in FIG. 14, in some aspects, process 1400 may include monitoring according to a modified DRX cycle at a time after receiving the control element (block 1420). For example, the UE (e.g., using reception component 1902 and/or communication manager 1906) may monitor according to a modified DRX cycle at a time after receiving the control element, as described herein.

Process 1400 may include additional aspects, such as any single aspect or any combination of aspects described below and/or in connection with one or more other processes described elsewhere herein.

In a first aspect, process 1400 includes receiving (e.g., using reception component 1902 and/or communication manager 1906) an RRC reconfiguration, indicating the modified DRX cycle, after receiving the control element, and the UE monitors according to the modified DRX cycle in response to the RRC reconfiguration.

In a second aspect, alone or in combination with the first aspect, the modified DRX cycle includes the DRX cycle shortened by a reception time of the control element, and the UE monitors according to the modified DRX cycle in response to the control element.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, at a network node or an apparatus of a network node. Example process 1500 is an example where the apparatus or the network node (e.g., network node 110) performs operations associated with DRX configuration updates.

As shown in FIG. 15, in some aspects, process 1500 may include receiving traffic information including a packet periodicity associated with one or more traffic flows (block 1510). For example, the network node (e.g., using reception component 1802 and/or communication manager 1806, depicted in FIG. 18) may receive traffic information including a packet periodicity associated with one or more traffic flows, as described herein.

As further shown in FIG. 15, in some aspects, process 1500 may include transmitting a control element, associated with a DRX cycle, based at least in part on the traffic information (block 1520). For example, the network node (e.g., using transmission component 1804 and/or communication manager 1806, depicted in FIG. 18) may transmit a control element, associated with a DRX cycle, based at least in part on the traffic information, as described herein.

Process 1500 may include additional aspects, such as any single aspect or any combination of aspects described below and/or in connection with one or more other processes described elsewhere herein.

In a first aspect, process 1500 includes transmitting (e.g., using transmission component 1804 and/or communication manager 1806) an RRC reconfiguration, indicating a modified DRX cycle, at a time after transmitting the control element.

In a second aspect, alone or in combination with the first aspect, a modified DRX includes the DRX cycle shortened by the control element, and the network node transmits according to the modified DRX cycle.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication. The apparatus 1600 may be a traffic source or an AF, or a traffic source or an AF may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 565 described in connection with FIG. 5. As shown, the apparatus 1600 may communicate with another apparatus 1608, such as a network function, a UE, or a network node (such as a CU, a DU, an RU, or a base station), using the reception component 1602 and the transmission component 1604.

In some aspects, the apparatus 1600 may be configured to perform one or more operations described herein in connection with FIG. 6A or 6B. Additionally, or alternatively, the apparatus 1600 may be configured to perform one or more processes described herein, such as process 900 of FIG. 9, or a combination thereof. In some aspects, the apparatus 1600 and/or one or more components shown in FIG. 16 may include one or more components of the traffic source or application function described in connection with FIG. 1 and FIG. 2. Additionally, or alternatively, one or more components shown in FIG. 16 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, one or more modems, one or more demodulators, one or more MIMO detectors, one or more receive processors, one or more controllers/processors, one or more memories, or a combination thereof, of the traffic source or application function described in connection with FIG. 1 and FIG. 2.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, one or more modems, one or more modulators, one or more transmit MIMO processors, one or more transmit processors, one or more controllers/processors, one or more memories, or a combination thereof, of the traffic source or application function described in connection with FIG. 1 and FIG. 2. In some aspects, the transmission component 1604 may be co-located with the reception component 1602 in one or more transceivers.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

In some aspects, the communication manager 1606 may determine traffic information including a packet periodicity associated with one or more traffic flows. Accordingly, the transmission component 1604 may transmit (e.g., to the apparatus 1608) the traffic information including an identifier related to a first packet associated with the packet periodicity.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication. The apparatus 1700 may be a network function, or a network function may include the apparatus 1700. In some aspects, the apparatus 1700 includes a reception component 1702, a transmission component 1704, and/or a communication manager 1706, which may be in communication with one another (for example, via one or more buses and/or one or more other components). In some aspects, the communication manager 1706 is the communication manager 570 described in connection with FIG. 5. Alternatively, the communication manager 1706 is the communication manager 575 described in connection with FIG. 5. As shown, the apparatus 1700 may communicate with another apparatus 1708, such as a traffic source, an AF, a UE, or a network node (such as a CU, a DU, an RU, or a base station), using the reception component 1702 and the transmission component 1704.

In some aspects, the apparatus 1700 may be configured to perform one or more operations described herein in connection with FIGS. 6A, 6B, and/or 7. Additionally, or alternatively, the apparatus 1700 may be configured to perform one or more processes described herein, such as process 1000 of FIG. 10, process 1100 of FIG. 11, or a combination thereof. In some aspects, the apparatus 1700 and/or one or more components shown in FIG. 17 may include one or more components of the network function described in connection with FIG. 1 and FIG. 2. Additionally, or alternatively, one or more components shown in FIG. 17 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1702 may receive communications, such as reference signals, control information, data communications, or a combination thereof, from the apparatus 1708. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, one or more modems, one or more demodulators, one or more MIMO detectors, one or more receive processors, one or more controllers/processors, one or more memories, or a combination thereof, of the network function described in connection with FIG. 1 and FIG. 2.

The transmission component 1704 may transmit communications, such as reference signals, control information, data communications, or a combination thereof, to the apparatus 1708. In some aspects, one or more other components of the apparatus 1700 may generate communications and may provide the generated communications to the transmission component 1704 for transmission to the apparatus 1708. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1708. In some aspects, the transmission component 1704 may include one or more antennas, one or more modems, one or more modulators, one or more transmit MIMO processors, one or more transmit processors, one or more controllers/processors, one or more memories, or a combination thereof, of the network function described in connection with FIG. 1 and FIG. 2. In some aspects, the transmission component 1704 may be co-located with the reception component 1702 in one or more transceivers.

The communication manager 1706 may support operations of the reception component 1702 and/or the transmission component 1704. For example, the communication manager 1706 may receive information associated with configuring reception of communications by the reception component 1702 and/or transmission of communications by the transmission component 1704. Additionally, or alternatively, the communication manager 1706 may generate and/or provide control information to the reception component 1702 and/or the transmission component 1704 to control reception and/or transmission of communications.

In some aspects, the apparatus 1700 may be associated with a control plane. Accordingly, the reception component 1702 may receive (e.g., from a traffic source and/or an AF) traffic information including a packet periodicity associated with one or more traffic flows and an identifier related to a first packet associated with the packet periodicity. The transmission component 1704 may transmit (e.g., to a network node) the traffic information.

Alternatively, the apparatus 1700 may be associated with a user plane. Accordingly, the reception component 1702 may receive traffic information including a packet periodicity associated with one or more traffic flows. The transmission component 1704 may transmit (e.g., to a network node) the traffic information. In some aspects, the communication manager 1706 may encode the traffic information in one or more fields of a GTP header, such that the transmission component 1704 may transmit the GTP header (e.g., to the network node).

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

FIG. 18 is a diagram of an example apparatus 1800 for wireless communication. The apparatus 1800 may be a network node, or a network node may include the apparatus 1800. In some aspects, the apparatus 1800 includes a reception component 1802, a transmission component 1804, and/or a communication manager 1806, which may be in communication with one another (for example, via one or more buses and/or one or more other components). In some aspects, the communication manager 1806 is the communication manager 150 described in connection with FIG. 1. Additionally, or alternatively, the communication manager 1806 is the communication manager 150a and/or the communication manager 150b described in connection with FIG. 4. As shown, the apparatus 1800 may communicate with another apparatus 1808, such as a network function, a UE, or a network node (such as a CU, a DU, an RU, or a base station), using the reception component 1802 and the transmission component 1804.

In some aspects, the apparatus 1800 may be configured to perform one or more operations described herein in connection with FIGS. 7 and/or 8. Additionally, or alternatively, the apparatus 1800 may be configured to perform one or more processes described herein, such as process 1200 of FIG. 12, process 1300 of FIG. 13, process 1500 of FIG. 15, or a combination thereof. In some aspects, the apparatus 1800 and/or one or more components shown in FIG. 18 may include one or more components of the network node described in connection with FIG. 1 and FIG. 2. Additionally, or alternatively, one or more components shown in FIG. 18 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1802 may receive communications, such as reference signals, control information, data communications, or a combination thereof, from the apparatus 1808. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1800. In some aspects, the reception component 1802 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1802 and/or the transmission component 1804 may include or may be included in a network interface. The network interface may be configured to obtain and/or output signals for the apparatus 1800 via one or more communications links, such as a backhaul link, a midhaul link, and/or a fronthaul link.

The transmission component 1804 may transmit communications, such as reference signals, control information, data communications, or a combination thereof, to the apparatus 1808. In some aspects, one or more other components of the apparatus 1800 may generate communications and may provide the generated communications to the transmission component 1804 for transmission to the apparatus 1808. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1808. In some aspects, the transmission component 1804 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1804 may be co-located with the reception component 1802 in one or more transceivers.

The communication manager 1806 may support operations of the reception component 1802 and/or the transmission component 1804. For example, the communication manager 1806 may receive information associated with configuring reception of communications by the reception component 1802 and/or transmission of communications by the transmission component 1804. Additionally, or alternatively, the communication manager 1806 may generate and/or provide control information to the reception component 1802 and/or the transmission component 1804 to control reception and/or transmission of communications.

In some aspects, the apparatus 1800 may be associated with a CU-UP. Accordingly, the reception component 1802 may receive (e.g., from a network function) traffic information including a packet periodicity associated with one or more traffic flows. The transmission component 1804 may transmit (e.g., to a CU-CP) the traffic information. The reception component 1802 may receive an acknowledgement (e.g., from the CU-CP) that the traffic information has been used.

Alternatively, the apparatus 1800 may be associated with a CU-CP. Accordingly, the reception component 1802 may receive (e.g., from the CU-UP) traffic information including a packet periodicity associated with one or more traffic flows. The transmission component 1804 may transmit an acknowledgement (e.g., to the CU-UP) that the traffic information has been used. In some aspects, the transmission component 1804 may transmit a DRX configuration (e.g., to a DU and/or a UE) based at least in part on the traffic information. Accordingly, the transmission component 1804 may transmit the acknowledgement in response to transmitting the DRX configuration.

In some aspects, the apparatus 1800 may be included a network node communication with a UE. For example, the reception component 1802 may receive traffic information (e.g., from a network function and/or from another part of the network node) including a packet periodicity associated with one or more traffic flows. Accordingly, the transmission component 1804 may transmit (e.g., to the UE) a control element, associated with a DRX cycle, based at least in part on the traffic information. Additionally, in some aspects, the transmission component 1804 may transmit (e.g., to the UE) an RRC reconfiguration, indicating a modified DRX cycle, at a time after transmitting the control element.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

FIG. 19 is a diagram of an example apparatus 1900 for wireless communication. The apparatus 1900 may be a UE, or a UE may include the apparatus 1900. In some aspects, the apparatus 1900 includes a reception component 1902, a transmission component 1904, and/or a communication manager 1906, which may be in communication with one another (for example, via one or more buses and/or one or more other components). In some aspects, the communication manager 1906 is the communication manager 140 described in connection with FIG. 1. As shown, the apparatus 1900 may communicate with another apparatus 1908, such as a UE or a network node (such as a CU, a DU, an RU, or a base station), using the reception component 1902 and the transmission component 1904.

In some aspects, the apparatus 1900 may be configured to perform one or more operations described herein in connection with FIGS. 7 and/or 8. Additionally, or alternatively, the apparatus 1900 may be configured to perform one or more processes described herein, such as process 1400 of FIG. 14, or a combination thereof. In some aspects, the apparatus 1900 and/or one or more components shown in FIG. 19 may include one or more components of the UE described in connection with FIG. 1 and FIG. 2. Additionally, or alternatively, one or more components shown in FIG. 19 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1902 may receive communications, such as reference signals, control information, data communications, or a combination thereof, from the apparatus 1908. The reception component 1902 may provide received communications to one or more other components of the apparatus 1900. In some aspects, the reception component 1902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1900. In some aspects, the reception component 1902 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1904 may transmit communications, such as reference signals, control information, data communications, or a combination thereof, to the apparatus 1908. In some aspects, one or more other components of the apparatus 1900 may generate communications and may provide the generated communications to the transmission component 1904 for transmission to the apparatus 1908. In some aspects, the transmission component 1904 may perform signal processing on the generated communications (such as filtering, amplification, modulation, digital-to-analog conversion, multiplexing, interleaving, mapping, or encoding, among other examples), and may transmit the processed signals to the apparatus 1908. In some aspects, the transmission component 1904 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1904 may be co-located with the reception component 1902 in one or more transceivers.

The communication manager 1906 may support operations of the reception component 1902 and/or the transmission component 1904. For example, the communication manager 1906 may receive information associated with configuring reception of communications by the reception component 1902 and/or transmission of communications by the transmission component 1904. Additionally, or alternatively, the communication manager 1906 may generate and/or provide control information to the reception component 1902 and/or the transmission component 1904 to control reception and/or transmission of communications.

In some aspects, the reception component 1902 may receive (e.g., from the apparatus 1908) a control element associated with a DRX cycle performed by the apparatus 1900. Accordingly, the reception component 1902 and/or the communication manager 1906 may monitor according to a modified DRX cycle at a time after receiving the control element. Additionally, in some aspects, the reception component 1902 may receive (e.g., from the apparatus 1908) an RRC reconfiguration, indicating the modified DRX cycle, after receiving the control element; therefore, the reception component 1902 and/or the communication manager 1906 may monitor according to the modified DRX cycle in response to the RRC reconfiguration.

The number and arrangement of components shown in FIG. 19 are provided as an example. In practice, there may be additional components, fewer components, different components, or differently arranged components than those shown in FIG. 19. Furthermore, two or more components shown in FIG. 19 may be implemented within a single component, or a single component shown in FIG. 19 may be implemented as multiple, distributed components. Additionally, or alternatively, a set of (one or more) components shown in FIG. 19 may perform one or more functions described as being performed by another set of components shown in FIG. 19.

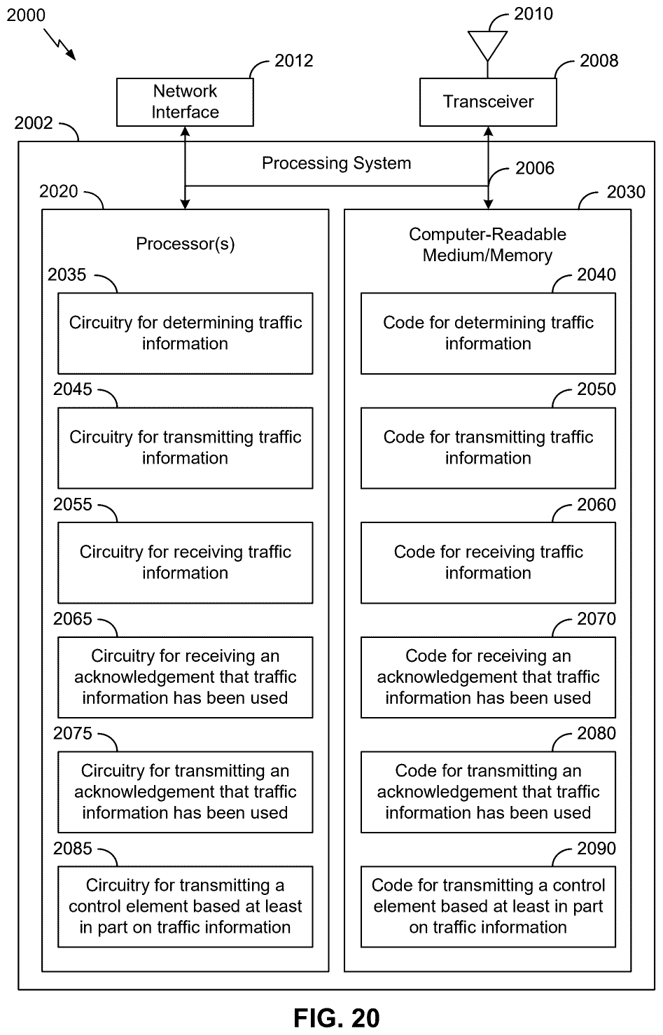

FIG. 20 is a diagram illustrating an example of an implementation of code and circuitry for a communications device 2000. The communications device 2000 may be a network element (such as a traffic source 560 or a network function, as described with regard to FIG. 5, or a network node 110 or a disaggregated base station, as described with regard to FIG. 3), or a network element may include the communications device 2000.

The communications device 2000 includes a processing system 2002 coupled to a transceiver 2008 (e.g., a transmitter and/or a receiver, and which may include a single transceivers or multiple transceivers which may perform different operations described as being performed by the transceiver 2008). The transceiver 2008 is configured to transmit and receive signals for the communications device 2000 via an antenna 2010 (e.g., one or more antennas), such as the various signals as described herein. The network interface 2012 is configured to obtain and send signals for the communications device 2000 via communications link(s), such as a backhaul link, midhaul link, and/or fronthaul link as described herein, such as with respect to FIG. 3. The processing system 2002 may be configured to perform processing functions for the communications device 2000, including processing signals received and/or to be transmitted by the communications device 2000.

The processing system 2002 includes one or more processors 2020. In various aspects, the one or more processors 2020 may include one or more of MIMO detector 236, receive processor 238, transmit processor 214, TX MIMO processor 216, and/or controller/processor 240, as described with respect to FIG. 2. The one or more processors 2020 are coupled to a computer-readable medium/memory 2030 via a bus 2006. In various aspects, the computer-readable medium/memory 2030 may include one or more memories such as memory 242, as described with respect to FIG. 2. In certain aspects, the computer-readable medium/memory 2030 is configured to store instructions (e.g., computer-executable code, processor-executable code) that when executed by the one or more processors 2020, cause the one or more processors 2020 to perform the method 900 described with respect to FIG. 9, method 1000 described with respect to FIG. 10, method 1100 described with respect to FIG. 11, method 1200 described with respect to FIG. 12, method 1300 described with respect to FIG. 13, method 1500 described with respect to FIG. 15, and/or any aspect related to them. Note that reference to a processor performing a function of communications device 2000 may include one or more processors performing that function of communications device 2000. Note also that reference to one or more processors performing multiple functions may include a first processor performing a first function of the multiple functions and a second processor performing a second function of the multiple functions.

As shown in FIG. 20, the communications device 2000 may include circuitry for determining traffic information including a packet periodicity associated with one or more traffic flows (circuitry 2035).

As shown in FIG. 20, the communications device 2000 may include, stored in computer-readable medium/memory 2030, code for determining traffic information including a packet periodicity associated with one or more traffic flows (code 2040).

As shown in FIG. 20, the communications device 2000 may include circuitry for transmitting traffic information (circuitry 2045).

As shown in FIG. 20, the communications device 2000 may include, stored in computer-readable medium/memory 2030, code for transmitting traffic information (code 2050).

As shown in FIG. 20, the communications device 2000 may include circuitry for receiving traffic information (circuitry 2055).

As shown in FIG. 20, the communications device 2000 may include, stored in computer-readable medium/memory 2030, code for receiving traffic information (code 2060).

As shown in FIG. 20, the communications device 2000 may include circuitry for receiving an acknowledgement that traffic information has been used (circuitry 2065).

As shown in FIG. 20, the communications device 2000 may include, stored in computer-readable medium/memory 2030, code for receiving an acknowledgement that traffic information has been used (code 2070).

As shown in FIG. 20, the communications device 2000 may include circuitry for transmitting an acknowledgement that traffic information has been used (circuitry 2075).

As shown in FIG. 20, the communications device 2000 may include, stored in computer-readable medium/memory 2030, code for transmitting an acknowledgement that traffic information has been used (code 2080).

As shown in FIG. 20, the communications device 2000 may include circuitry for transmitting a control element (associated with a DRX cycle) based at least in part on traffic information (circuitry 2085).

As shown in FIG. 20, the communications device 2000 may include, stored in computer-readable medium/memory 2030, code for transmitting a control element (associated with a DRX cycle) based at least in part on traffic information (code 2090).

Various components of the communications device 2000 may provide means for performing the method 900 described with respect to FIG. 9, method 1000 described with respect to FIG. 10, method 1100 described with respect to FIG. 11, method 1200 described with respect to FIG. 12, method 1300 described with respect to FIG. 13, method 1500 described with respect to FIG. 15, and/or any aspect related to them. For example, means for transmitting, sending, or outputting for transmission may include the modem(s) 232 and/or antenna(s) 234 of the network node 110 and/or the transceiver 2008 and/or antenna 2010 of the communications device 2000 in FIG. 20. Means for receiving or obtaining may include the modem(s) 232 and/or antenna(s) 234 of the network node 110 and/or the transceiver 2008 and/or antenna 2010 of the communications device 2000 in FIG. 20.

FIG. 20 is provided as an example. Other examples may differ from what is described in connection with FIG. 20.

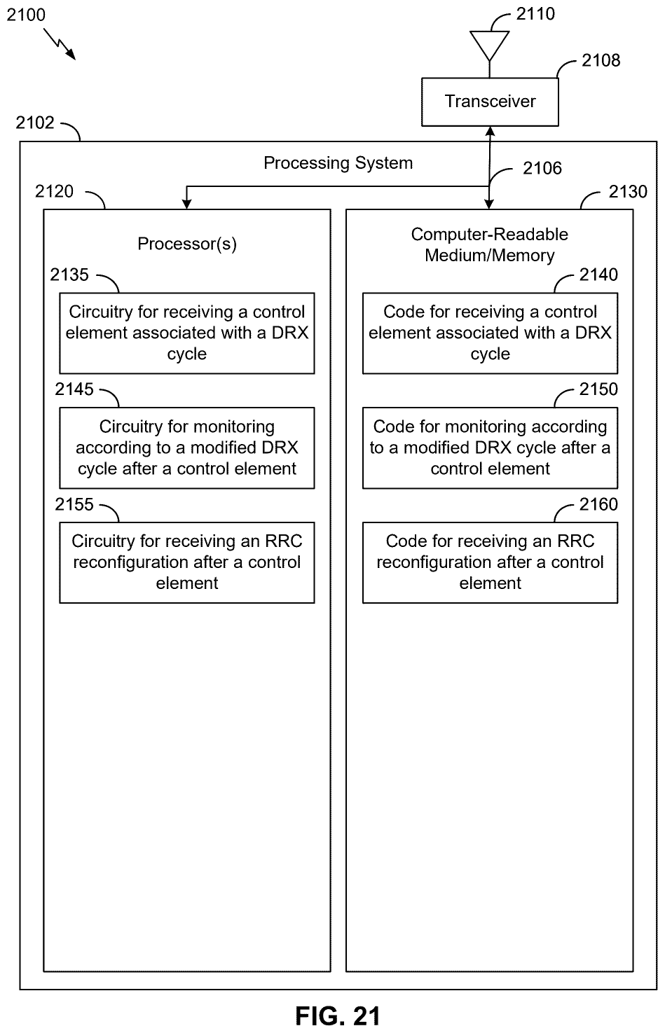

FIG. 21 is a diagram illustrating an example of an implementation of code and circuitry for a communications device 2100. The communications device 2100 may be a UE, or a UE may include the communications device 2100.

The communications device 2100 includes a processing system 2102 coupled to a transceiver 2108 (e.g., a transmitter and/or a receiver, and which may include a single transceivers or multiple transceivers which may perform different operations described as being performed by the transceiver 2108). The transceiver 2108 is configured to transmit and receive signals for the communications device 2100 via an antenna 2110, such as the various signals as described herein. The processing system 2102 may be configured to perform processing functions for the communications device 2100, including processing signals received and/or to be transmitted by the communications device 2100.

The processing system 2102 includes one or more processors 2120. In various aspects, the one or more processors 2120 may include one or more of MIMO detector 256, receive processor 258, transmit processor 264, TX MIMO processor 266, and/or controller/processor 280, as described with respect to FIG. 2. The one or more processors 2120 are coupled to a computer-readable medium/memory 2130 via a bus 2106. In various aspects, the computer-readable medium/memory 2130 may include one or more memories such as memory 282, as described with respect to FIG. 2. In certain aspects, the computer-readable medium/memory 2130 is configured to store instructions (e.g., computer-executable code, processor-executable code) that when executed by the one or more processors 2120, cause the one or more processors 2120 to perform the method 1400 described with respect to FIG. 14, or any aspect related to it. Note that reference to a processor performing a function of communications device 2100 may include one or more processors performing that function of communications device 2100. Note also that reference to one or more processors performing multiple functions may include a first processor performing a first function of the multiple functions and a second processor performing a second function of the multiple functions.

As shown in FIG. 21, the communications device 2100 may include circuitry for receiving a control element associated with a DRX cycle (circuitry 2135).

As shown in FIG. 21, the communications device 2100 may include, stored in computer-readable medium/memory 2130, code for receiving a control element associated with a DRX cycle (code 2140).

As shown in FIG. 21, the communications device 2100 may include circuitry for monitoring according to a modified DRX cycle after a control element (circuitry 2145).

As shown in FIG. 21, the communications device 2100 may include, stored in computer-readable medium/memory 2130, code for monitoring according to a modified DRX cycle after a control element (code 2150).

As shown in FIG. 21, the communications device 2100 may include circuitry for receiving an RRC reconfiguration after a control element (circuitry 2155).

As shown in FIG. 21, the communications device 2100 may include, stored in computer-readable medium/memory 2130, code for receiving an RRC reconfiguration after a control element (code 2160).

Various components of the communications device 2100 may provide means for performing the method 1400 described with respect to FIG. 14, or any aspect related to it. For example, means for transmitting, sending, or outputting for transmission may include the modem(s) 254 and/or antenna(s) 252 of the UE 120 and/or transceiver 2108 and antenna 2110 of the communications device 2100 in FIG. 21. Means for receiving or obtaining may include the modem(s) 254 and/or antenna(s) 252 of the UE 120 and/or transceiver 2108 and antenna 2110 of the communications device 2100 in FIG. 21.

FIG. 21 is provided as an example. Other examples may differ from what is described in connection with FIG. 21.

The following provides an overview of some Aspects of the present disclosure:

Aspect 1: A method of wireless communication performed by a traffic source or application function, comprising: determining traffic information including a packet periodicity associated with one or more traffic flows; and transmitting, to a network function, the traffic information including an identifier related to a first packet associated with the packet periodicity.

Aspect 2: The method of Aspect 1, wherein the identifier is included in a real time protocol (RTP) packet header or an RTP packet header extension.

Aspect 3: The method of Aspect 1, wherein the identifier is included in a QUIC packet field.

Aspect 4: The method of any of Aspects 1-3, wherein the identifier comprises a protocol data unit set sequence number.

Aspect 5: The method of any of Aspects 1-3, wherein the identifier comprises a packet number.

Aspect 6: The method of any of Aspects 1-5, wherein the identifier indicates the first packet, and the traffic information is activated at the first packet.

Aspect 7: The method of any of Aspects 1-5, wherein the identifier indicates an earlier packet, the identifier indicates a duration between the earlier packet and the first packet, and the traffic information is activated after the duration has passed.

Aspect 8: The method of any of Aspects 1-7, wherein the traffic information includes a jitter associated with the one or more traffic flows.

Aspect 9: The method of any of Aspects 1-8, wherein the traffic information includes an identifier associated with the one or more traffic flows.

Aspect 10: A method of wireless communication performed by a network function, comprising: receiving traffic information including a packet periodicity associated with one or more traffic flows and an identifier related to a first packet associated with the packet periodicity; and transmitting the traffic information to a network node.

Aspect 11: The method of Aspect 10, wherein the identifier is included in a real time protocol (RTP) packet header or an RTP packet header extension.

Aspect 12: The method of Aspect 10, wherein the identifier is included in a QUIC packet field.

Aspect 13: The method of any of Aspects 10-12, wherein the identifier comprises a protocol data unit set sequence number.

Aspect 14: The method of any of Aspects 10-12, wherein the identifier comprises a packet number.

Aspect 15: The method of any of Aspects 10-14, wherein the identifier indicates the first packet, and the traffic information is activated at the first packet.

Aspect 16: The method of any of Aspects 10-14, wherein the identifier indicates an earlier packet, the identifier indicates a duration between the earlier packet and the first packet, and the traffic information is activated after the duration has passed.

Aspect 17: The method of any of Aspects 10-16, wherein the traffic information includes a jitter associated with the one or more traffic flows.

Aspect 18: The method of any of Aspects 10-17, wherein the traffic information includes an identifier associated with the one or more traffic flows.

Aspect 19: A method of wireless communication performed by a user plane function (UPF), comprising: receiving traffic information including a packet periodicity associated with one or more traffic flows; and transmitting the traffic information to a network node.

Aspect 20: The method of Aspect 19, wherein the traffic information is included in a real time protocol packet header extension or a QUIC packet header.

Aspect 21: The method of any of Aspects 19-20, wherein the traffic information includes a jitter associated with the one or more traffic flows.

Aspect 22: The method of any of Aspects 19-21, wherein the traffic information includes an activation time associated with the packet periodicity.

Aspect 23: The method of any of Aspects 19-22, wherein transmitting the traffic information to the network node comprises: encoding the traffic information in one or more fields of a general packet radio service (GPRS) tunnelling protocol (GTP) header.

Aspect 24: A method of wireless communication performed by a user plane of a network node, comprising: receiving traffic information including a packet periodicity associated with one or more traffic flows; transmitting the traffic information to a control plane of the network node; and receiving an acknowledgement, from the control plane of the network node, that the traffic information has been used.

Aspect 25: The method of Aspect 24, wherein the traffic information is included in a general packet radio service (GPRS) tunnelling protocol (GTP) header.

Aspect 26: The method of any of Aspects 24-25, wherein transmitting the traffic information to the control plane of the network node comprises: transmitting an E1 application protocol message including the traffic information.

Aspect 27: The method of any of Aspects 24-26, wherein receiving the acknowledgement from the control plane of the network node comprises: receiving an E1 application protocol message including the acknowledgement.

Aspect 28: A method of wireless communication performed by a control plane of a network node, comprising: receiving, from a user plane of the network node, traffic information including a packet periodicity associated with one or more traffic flows; and transmitting an acknowledgement, to the user plane of the network node, that the traffic information has been used.

Aspect 29: The method of Aspect 28, wherein the traffic information is included in an E1 application protocol message.

Aspect 30: The method of any of Aspects 28-29, wherein the acknowledgement is included in an E1 application protocol message.

Aspect 31: The method of any of Aspects 28-30, further comprising: transmitting a discontinuous reception (DRX) configuration based at least in part on the traffic information.

Aspect 32: The method of Aspect 31, wherein the DRX configuration is included in an F1 application protocol message to the control plane of the network node.

Aspect 33: The method of any of Aspects 31-32, wherein the DRX configuration is included in a radio resource control message to a user equipment.

Aspect 34: A method of wireless communication performed by a user equipment (UE), comprising: receiving a control element associated with a discontinuous reception (DRX) cycle performed by the UE; and monitoring according to a modified DRX cycle at a time after receiving the control element.

Aspect 35: The method of Aspect 34, further comprising: receiving a radio resource control (RRC) reconfiguration, indicating the modified DRX cycle, after receiving the control element, wherein the UE monitors according to the modified DRX cycle in response to the RRC reconfiguration.

Aspect 36: The method of Aspect 34, wherein the modified DRX cycle comprises the DRX cycle shortened by a reception time of the control element, and wherein the UE monitors according to the modified DRX cycle in response to the control element.

Aspect 37: A method of wireless communication performed by a network node, comprising: receiving traffic information including a packet periodicity associated with one or more traffic flows; and transmitting a control element, associated with a discontinuous reception (DRX) cycle, based at least in part on the traffic information.

Aspect 38: The method of Aspect 37, further comprising: transmitting a radio resource control (RRC) reconfiguration, indicating a modified DRX cycle, at a time after transmitting the control element.

Aspect 39: The method of Aspect 37, wherein a modified DRX comprises the DRX cycle shortened by the control element, and wherein the network node transmits according to the modified DRX cycle.

Aspect 40: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-39.

Aspect 41: An apparatus for wireless communication at a device, the apparatus comprising one or more memories and one or more processors coupled to the one or more memories, the one or more processors configured to cause the device to perform the method of one or more of Aspects 1-39.

Aspect 42: An apparatus for wireless communication, the apparatus comprising at least one means for performing the method of one or more of Aspects 1-39.

Aspect 43: A non-transitory computer-readable medium storing code for wireless communication, the code comprising instructions executable by one or more processors to perform the method of one or more of Aspects 1-39.

Aspect 44: A non-transitory computer-readable medium storing a set of instructions for wireless communication, the set of instructions comprising one or more instructions that, when executed by one or more processors of a device, cause the device to perform the method of one or more of Aspects 1-39.

Aspect 45: A device for wireless communication, the device comprising a processing system that includes one or more processors and one or more memories coupled with the one or more processors, the processing system configured to cause the device to perform the method of one or more of Aspects 1-39.

Aspect 46: An apparatus for wireless communication at a device, the apparatus comprising one or more memories and one or more processors coupled to the one or more memories, the one or more processors individually or collectively configured to cause the device to perform the method of one or more of Aspects 1-39.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus configured for communication, comprising:
one or more memories comprising processor-executable instructions; and
one or more processors configured to execute the processor-executable instructions and cause the apparatus to:
receive traffic information including a packet periodicity associated with one or more traffic flows; and
transmit the traffic information to a network node.

2. The apparatus of claim 1, wherein the traffic information includes an identifier related to a first packet associated with the packet periodicity.

3. The apparatus of claim 2, wherein the identifier is included in a real time protocol (RTP) packet header or an RTP packet header extension.

4. The apparatus of claim 2, wherein the identifier comprises a protocol data unit set sequence number.

5. The apparatus of claim 2, wherein the identifier is included in a QUIC packet field.

6. The apparatus of claim 2, wherein the identifier comprises a packet number.

7. The apparatus of claim 2, wherein the identifier indicates the first packet, and the traffic information is activated at the first packet.

8. The apparatus of claim 2, wherein the identifier indicates an earlier packet, the identifier indicates a duration between the earlier packet and the first packet, and the traffic information is activated after the duration has passed.

9. The apparatus of claim 1, wherein the traffic information includes a jitter associated with the one or more traffic flows.

10. The apparatus of claim 1, wherein the traffic information includes an identifier associated with the one or more traffic flows.

11. The apparatus of claim 1, wherein the traffic information is included in a real time protocol packet header extension or a QUIC packet header.

12. The apparatus of claim 1, wherein the traffic information includes an activation time associated with the packet periodicity.

13. The apparatus of claim 1, wherein, to transmit the traffic information to the network node, the one or more processors are configured to cause the apparatus to: encode the traffic information in one or more fields of a general packet radio service (GPRS) tunnelling protocol (GTP) header.

14. A method of wireless communication performed by a network function, comprising:
receiving traffic information including a packet periodicity associated with one or more traffic flows; and
transmitting the traffic information to a network node.

15. The method of claim 14, wherein the traffic information includes an identifier related to a first packet associated with the packet periodicity.

16. The method of claim 15, wherein the identifier is included in a real time protocol (RTP) packet header, an RTP packet header extension, or a QUIC packet field.

17. The method of claim 15, wherein the identifier comprises a protocol data unit set sequence number or a packet number.

18. The method of claim 15, wherein the identifier indicates the first packet, and the traffic information is activated at the first packet.

19. The method of claim 15, wherein the identifier indicates an earlier packet, the identifier indicates a duration between the earlier packet and the first packet, and the traffic information is activated after the duration has passed.

20. A non-transitory computer-readable medium storing a set of instructions for wireless communication, the set of instructions comprising:
one or more instructions that, when executed by one or more processors of a network function, cause the network function to:
receive traffic information including a packet periodicity associated with one or more traffic flows; and
transmit the traffic information to a network node.
